(19) United States
(12) Patent Application Publication
(10) Pub. No.: US 2006/0286379 A1
(43) Pub. Date: Dec. 21, 2006

(54) Magnetic nanoparticle supports

(76) Inventor: Yong Gao, Carbondale, IL (US)

Correspondence Address: Patrick W. Rasche;Armstrong Teasdale LLP, One Metropolitan Square, Suite 2600, St. Louis, MO, 63102, US

(21) Appl. No.: 10/640,126

(22) Filed: Aug. 13, 2003

Related U.S. Application Data
(60) Provisional application No. 60/403,332, filed on Aug. 13, 2002.

(51) Int. Cl. B32B 1/00; B05D 7/00

(52) U.S. Cl. 428/403; 977/838; 977/811; 427/215

(57) ABSTRACT

Coated magnetic nanoparticles and their compositions used for labeling, detecting, sorting, and isolating biological, organic and inorganic molecules, and for medical therapies, and as a platform for organic, biological and physical transformations. An oxidation approach for fabricating iron oxide nanoparticles, methods for the synthesis of magnetic compositions comprising a magnetic core associated with a functional molecule or molecular complexes, and methods for the synthesis of water-soluble magnetic particles/compositions.

This application claims priority of copending U.S. provisional application Ser. No. 60/403,332, filed Aug. 13, 2002 which is incorporated herein in its entirety by reference.

### FIELD OF THE INVENTION

This invention relates generally to coated magnetic nanoparticles. More particularly this invention relates to a process for preparing coated magnetic nanoparticle supports and the use of magnetic nanoparticles in separation and recovery processes. The invention also relates to uses of coated magnetic nanoparticles as platforms for biologic and chemical processes, for recovery and separation of recoverable and separable components and from process streams of biomedical, biotechnology and chemical process industries.

### BACKGROUND OF THE INVENTION

Magnetism exhibited by magnetic nanoparticles has attracted research attention and industrial interests in such particles. Magnetic particles, especially those in the nanometer regime have attractive physical properties such as very high surface area, relatively small size and magnetic properties.

These attractive magnetic properties include paramagnetic, ferromagnetic, anti-ferromagnetic, diamagnetic and superparamagnetic properties making magnetic particles an especially desired particle class. Moreover below a critical size in the nanometer range, magnetic nanoparticles become single-domain and exhibit unique and desirable size- and shape-dependent physical and chemical properties such as superparamagnetism, quantum tunneling of the magnetization, and unusually large coercivities.

Magnetic nanoparticle supports are used in information storage systems, refrigeration systems, drug delivery, MRI imaging, and ferrofluids. Shafi, et al., Langmuir, 17: 5093-5097, 2001; Ni, et al., Chem. Mater. 14: 1048-1052, 2002; Xiong, et al., Chem. Mater. 13: 1943-1945, 2001 disclose some known processes for preparing magnetic particles.

Magnetic nanoparticles self attract and so to prevent the self-aggregation of magnetic nanoparticles due to magnetic attraction, coating materials are generally employed to surround the magnetic cores of magnetic nanoparticle and to stabilize the magnetic nanoparticles. Very different physical properties, especially magnetic properties have been observed with magnetic nanoparticles having similar microstructures such as grain sizes, size uniformity and crystallinity but possessing different coatings.

It is also desired to provide new uses for magnetic nanoparticles having new coating compositions. It is also desired to provide new coatings for magnetic particles which have enhanced functionalities. Despite advances in the art of preparing nanomagnetic particles it is still desired to provide an enhanced process for preparing magnetic nanoparticles including new coating compositions.

Bio processes and other chemical processes yield a wide variety of products and byproducts in unstructured models. Such processes provide a wide range of high value products such as hormones, vitamins or antibiotics for which enhanced separation and recovery processes are needed.

### BRIEF DESCRIPTION OF THE INVENTION

In an aspect this invention comprises coated magnetic oxide nanocrystal having a particle size in the range from about 0.1 nm to about 1000 nm.

In an aspect the invention comprises a multi-component coated nanocrystal composition with an inner composition comprising magnetic oxide nanocrystals having a narrow size distribution of as low as ±10%.

In another aspect the invention comprises a multi-component coated nanocrystal composition having a magnetic component comprising magnetic oxide nanocrystals. In an aspect the magnetic component comprises a core. In an aspect the magnetic component is an inner composition.

In an aspect a process for preparing a multi-component coated nanocrystal composition with an inner composition comprising magnetic oxide nanocrystals and an outer composition comprising at least one of a ligand and a surfactant comprises oxiding a metal composition suitable for use as an inner composition with an oxidant in the presence of excess organic surfactant.

In an aspect a process for preparing a multicomponent coated composition comprising an inner composition comprising magnetic oxide nanocrystals and as a coat an outer composition comprising a place exchangeable ligand comprises admixing a surfactant coated magnetic particle core with an aqueous composition comprising a water soluble ligand.

In an aspect, process for preparing a ligand coated magnetic oxide nanoparticle core comprises admixing a surfactant coated magnetic particle core with a water solubilizing coating composition comprising a water soluble ligand.

In an aspect a process for preparing an organic surfactant coated magnetic oxide nanocrystals comprises oxidizing a metal composition suitable for use as a magnetic oxide nanocrystal with an oxidant in the presence of excess organic surfactant.

In an aspect, a process for preparing a ligand coated magnetic nanoparticle core comprises admixing a surfactant coated magnetic particle core with a excessive water solubilizing coating composition comprising a water soluble ligand.

In another aspect, a process is provided for preparing magnetic nanoparticles having inorganic magnetic nanoparticle core protected with a layer(s) of organic polymeric coatings, which comprises admixing a polymerizable monomer with a composition containing a coated magnetic particle in the presence of an initiator and polymerizing the monomer.

In another aspect, a process is provided for preparing magnetic nanoparticles having inorganic cores protected with a shell layer(s) of organic polymeric coatings, which comprises admixing a polymerizable biological monomer with a composition containing a coated magnetic particle in the presence of an effective amount of an initiator and polymerizing the biological monomer to form a shell layer on the magnetic nanoparticles.

In another aspect, a process is provided for using coated magnetic nanoparticles as a host for a moiety selected from the group consisting of reagent, catalysts, scavenger, reaction byproduct, product and any intermediate which comprises utilizing as a coating on the coated magnetic nanoparticle a coating selected from the group consisting of organic molecule, polymer including crosslinked polymer, biological polymer, silica having a functional affinity for reagent, catalyst, scavenger, reaction byproduct and product.

In another aspect, a process is provided for using coated magnetic nanoparticles for supporting organic and biological transformations, which comprises utilizing as a coating on the coated magnetic nanoparticle a coating selected from the group consisting of organic molecule, polymer including crosslinked polymer, biological polymer and silica which effectively exhibits a functional affinity for organic and biological transformations.

### BRIEF DESCRIPTION OF THE DRAWINGS

FIG. 1 is a pictorial depiction of a synthesis scheme for preparing surfactant coated Fe₂O₃ nanoparticles via an oxidation process.

FIG. 2 is a pictorial depiction of a synthesis scheme of a water-soluble coated magnetic composition via a place-exchange process.

FIG. 3 is a pictorial depiction of a synthesis scheme of a water-soluble magnetic composition via an oxidation process.

FIG. 4 is a pictorial depiction of a process scheme for isolation of protein avidin by the use of a magnetic composition with the assistance of external magnetic forces.

FIG. 5 shows TEM images of the Fe₂O₃ nanoparticles coated with N-Methyl-N′-(6-carboxylhexyl)-4,4′-bipyridinium iodide bromide salt from the buffer solutions of (A) pH 3, (B) pH 7 and (C) pH 9.

FIG. 6A shows fluorescent spectra with an excitation wavelength of 497 nm and absorption spectra in FIG. 6B of avidin labeled with fluorescein isothiocyanate (avidin-FITC) in the phosphate buffered saline (PBS) buffer (pH 7.4) measured at room temperature. Lines (a): avidin-FITC in the PBS buffer before incubated with the Fe₂O₃ nanoparticles coated with (d)-(+)-biotin or the Fe₂O₃ nanoparticles coated with dipyrridium salt; (b): after incubation and removal of the Fe₂O₃ nanoparticles coated with (d)-(+)-biotin; (c): after incubation and removal of the biotin-free nanoparticles. The 96% isolation efficiency of the Fe₂O₃ nanoparticles coated with (d)-(+)-biotin was calculated based on the fluorescence intensities of (a) and (b) at 522 nm in (A). The same conclusion could be made by using absorptions of (a) and (b) at 497 nm in (B).

FIG. 6B shows the absorption spectra of avidin labeled with fluorescein isothiocyanate (avidin-FITC) in the phosphate buffered saline (PBS) buffer (pH 7.4) measured at room temperature. Lines (a): avidin-FITC in the PBS buffer before incubated with the Fe₂O₃ nanoparticles coated with (d)-(+)-biotin or the Fe₂O₃ nanoparticles coated with dipyrridium salt; (b): after incubation and removal of the Fe₂O₃ nanoparticles coated with (d)-(+)-biotin; (c): after incubation and removal of the biotin-free nanoparticles.

FIG. 7 is a pictorial depiction of a process scheme for the atom transfer radical polymerization synthesis of the non-crosslinked polystyrene/Fe₂O₃ nanoparticles.

FIG. 8 is a pictorial depiction of a process scheme for the atom transfer radical polymerization synthesis of the divinylbenzene-crosslinked polystyrene core/shell nanoparticles via the use of divinylbenzene as the crosslinking agent.

FIG. 9 shows (A) fluorescent spectra of 6-(1-pyrenyl)hexanoic acid in CHCl₃ (a) before and after site-exchange reactions with the core/shell Fe₂O₃ nanoparticles protected with (b) non-crosslinked (0% divinylbenzene), (c) 2%, (d) 6% and (e) 10% divinylbenzene-crosslinked polystyrene, respectively. The excitation wavelength was 378 nm. (B) Absorption spectra of 6-(1-pyrenyl)hexanoic acid in CHCl₃ (a) before and after site-exchange reactions with core/shell Fe₂O₃ nanoparticles protected with (b) non-crosslinked (0% divinylbenzene), (c) 2%, (d) 6% and (e) 10% divinylbenzene-crosslinked polystyrene, respectively.

FIG. 10 is a pictorial depiction of a process scheme for the atom transfer radical polymerization synthesis of the hydrophilic core/shell Fe₂O₃ nanoparticles.

FIG. 11 is a pictorial depiction of a process scheme for the synthesis of the water-soluble core/shell Fe₂O₃ nanoparticles linked with ethylenediaminetetracetic acid.

FIG. 12 is a pictorial depiction of a process scheme for a replacement reaction on the surfaces of nanoparticles.

FIG. 13 shows the inventor's test in the use of an array consisting of three small permanent magnets for the isolation of magnetic nanoparticles from three wells simultaneously.

FIG. 14 shows the inventor's test in the use of two permanent magnets at the underneath of two wells on a plate for concentrating magnetic nanoparticles to the bottom of two wells simultaneously.

FIG. 15 is a pictorial depiction of a process scheme for our synthesis of a pentapeptide using nanoparticle supports.

### DETAILED DESCRIPTION OF THE INVENTION

In an aspect the invention comprises a multi-component coated nanocrystal composition having a narrow size distribution of as low as ±10% with an inner composition comprising magnetic oxide nanocrystals. In an aspect the composition has an outer nonmagnetic composition comprising at least one of a surfactant and a ligand. In an aspect a coated magnetic iron oxide nanocrystal has as a core size a narrow size distribution of as low as ±10%, wherein the coating comprises a ligand with functional group(s). In an aspect the ligand comprises a place exchangeable ligand.

In another aspect the present invention provides coated magnetic oxide nanocrystal compositions capable of providing hosting platforms, reactive platforms and providing exchange replaceable surfaces on magnetic oxide particles. Such useful coating compositions are useful to selectively alter the physical properties of the magnetic nanoparticles and to provide provocative chemical reactive platforms. A coated particle, according to the present invention, is coated with the aqueous coating composition.

An initial coating on the magnetic oxide nanoparticle comprises a surfactant. This initial surfactant coating is temporarily retained on the magnetic oxide nanoparticle until the surfactant coating is selectively removed by contact with an appropriate successor coating place exchange moiety. It is understood that that contact is sufficient contact so as to enable the place change of the replacement successor ligand for a precursor ligand is successful. It is further understood that the place exchange occurs in whole or in part.

In another aspect, a process is provided for preparing magnetic nanoparticles having inorganic magnetic nanoparticle core protected with a layer(s) of organic polymeric coating, which comprises admixing a polymerizable monomer with a composition containing a coated magnetic particle in the presence of an initiator and polymerizing the monomer. In an aspect the polymerization is carried out to a degree which provides a desired molecular weight and molecular weight distribution. In an aspect the coating on the coated magnetic particle possesses a functionality that links the polymerizable monomers attached and/or not attached to the surface of the inorganic magnetic nanoparticles.

In another aspect, a process is provided for preparing magnetic nanoparticles having inorganic cores protected with a shell layer(s) of organic polymeric coating, which comprises admixing a polymerizable biological monomer with a composition containing a coated magnetic particle in the presence of an effective amount of an initiator and polymerizing the biological monomer to form a shell layer on the magnetic nanoparticles.

In another aspect, a process is provided for using the magnetic nanoparticles as a host for hosting reagents, catalysts, scavengers, reaction byproducts, products and any intermediates which comprises utilizing as a coating on the coated magnetic nanoparticle a coating comprising organic molecules, polymers including crosslinked polymers, biological polymers, silica having a functional affinity for reagents, catalysts, scavengers, reaction byproducts and products. In an aspect the attachment is carried out by effectively contacting a composition containing at least one of a reagent, catalyst, scavengers, reaction byproducts, product and any intermediates with the coated nanoparticle having a coat having an affinity for reagent, catalyst, scavengers, reaction byproducts, product and any intermediates.

In an aspect, throughout the specification and claims, the term “inner composition” is considered a magnetic component and the term “outer component” is considered a nonmagnetic component, i.e. (magnetic field permeable component).

In another aspect, a process is provided for using the magnetic nanoparticles for supporting organic and biological transformations, which comprises utilizing as a coating on the coated magnetic nanoparticle a coating comprising organic molecules, polymers including crosslinked polymers, biological polymers and silica which has and effectively exhibits a functional affinity for organic and biological transformations.

As used herein, the term “core/shell” means a magnetic nanoparticle residing in a core or inner component in a multi-component composition having a shell comprising a surfactant or ligand. Preferably the ligand is a reactively functionally capable ligand. Preferably the surfactant and ligand are chemically or otherwise receptive to place exchange.

As used herein the term “surfactant” includes a long alkyl chain ligand with a terminal —COOH with 3 carbon atoms in an alkyl chain.

As used herein the term “excess” surfactant means having an amount of surfactant present which is greater than that required for stoichimetry or normal adequacy of an amount of surfactant or ligand to be applied as a coating to the magnetic oxide particle under the conditions of such coating or application.

As used herein, the term “ligand” includes a reactable chemical moiety having an available functional group, for example, DNA, reagents and another group that can attach to the surfaces of cores such as covalently and non-covalently. In an aspect it is believed that ligands which are coated on the magnetic nanoparticle core function as a bridge to link the magnetic nanoparticle core (for example, as referred to as ferric oxide, ferrous oxide, iron, etc.) to a biological moiety attached thereto such as DNA (deoxyribonucleic acid). In an aspect the functionalities of the ligand(s) are functionally reactive.

In an aspect a nanoparticle herein is coated with a surfactant. In an aspect a nanoparticle is coated with a ligand and a surfactant. In an aspect, a nanoparticle is coated with a ligand.

The term “ligand” also refers to an organic compound either synthesized in the laboratory or found in nature, biological molecules that include proteins, nucleic acids, carbohydrates, lipids, antibodies/antigens, cells, subcellular organelles, and other biological molecules, and derivatives and any combinations and thereof.

The multicomponent composition comprises a magnetic component and a nonmagnetic (magnetic field permeable) components.

Moieties useful as surfactants herein generally do not have a functional group. The surfactant must have a —COOH group and at least 3 carbons in an alkyl portion.

As used herein the term “coating” includes a partial or complete coating which covers in whole or a magnetic nanoparticle generally on the outer surface of a magnetic nanoparticle which is sufficiently proximately spatially regionalized or localized to the nanoparticle.

As used herein the term “magnetic particle support” or “magnetic nanoparticle supports” includes the presence of a chemical moiety temporarily or permanently adhering to a magnetic nanoparticle.

It is understood that reaction conditions herein are such for the reactions recited that desired reactions can be successfully carried out producing desired results.

As used herein the term “hosting” includes the presence of a chemical moiety on which another chemical moiety is resident or temporarily or permanently is resident. The term host includes a graft or affixture. The host is receptive to relinquishing the hosted chemical moiety.

As used herein the term “platform” includes a surface or moiety face or ligand interface wherein another chemical moiety may temporarily be resident or adhere to and be a candidate for selective successor replacement or removal.

As used herein the term “provocative” means reactive and reactive with another reactive receptive chemical moiety including a DNA ligand.

Nonlimiting illustrative examples of “platform” include, but are not limited to, organic ligands such as hexanoic acid and 11-mercaptoundecanoic acid; organic polymers such as polystyrene, polyacrylate, poly(ethylene glycol), poly(acronitrile), poly(acrylate), polyethylene, poly(methyl methacrylate), poly(tetrafluoroethylene), polypropylene, ploy(vinyl chloride), poly(vinyl acetate), poly(1-vinylnaphtahlene), polyisobutene, and polyisoprene; inorganic polymers such as the condensed forms of tetraethylorthosilicate and polyaminopropyltrimethoxysilane; biological polymers of peptides such as alanine-alaine-phenyalanine, proteins such as avidin, polysaccharides such as starch, chitin and glycogen, nucleic acids such as adenosine-adenosine-adenosine, antibodies such as anti-avidin; derivatives, and anything combined thereof.

As used herein, the term “magnetic separation” refers to use of a magnetic field to remove selected or designated magnetic particles from a composition coating the magnetic particles.

As used herein, the term “adherent” includes a temporary or otherwise suitable effective adherence to a chemical moiety such as a nanoparticle core by another chemical moiety such as a surfactant or ligand either through a functional affinity or otherwise such as a proximately close spatial association. In an aspect the adherence is of permanent or temporary duration and is sufficient and effective.

The term “magnetic particle” includes particles having at least one of permanent magnetism paramagnetism, ferro magnetism, anti-ferromagnetism, diamagnetism or superparamagnetism and which reacts to magnetic fields such as having properties of a magnet. A magnet is any piece of iron, steel, alnico, etc. that has the property of attracting iron or steel.

As an option removal of a component of interest may be enhanced using the magnetism property of coated magnetic nanocrystal particles in a magnetic separation process. Illustratively, the coated magnetic nanocrystal particles are selected having a coating which has an affinity to form a complex with a component of interest in a multi-component composition. Such coated magnetic nanocrystal particles are placed in contact with the component of interest for a time and under conditions effective to form a complex. In an aspect the application of the magnetic field to the magnetic particle complex is employed to bend, sway and/or attract the magnetically directable coated magnetic nanocrystal complex toward or away from the imposed externally applied magnetic field. Typically a sufficient operative amount of magnetic field gradient is imposed on a container or vessel housing the multi-component composition which is magnetic field transmissive and magnetic field permeable. The nanoparticles are thus directed to a desired location such as to a separate storage vessel.

The magnetic field is typically supplied by a permanent magnet or energized electromagnet in the proximate effective vicinity of the composition and sufficiently enabled for the application of sufficient and effective magnetic field strength so as to guide, steer or direct a magnetic particle.

In an aspect, properties of the containers retention members are such that it allows the magnetic field to permeate the liquid holding container exterior walls (i.e. it is magnetic field permeable) into the composition being treated. In an option, a magnetic may be placed in the composition to be treated. The magnetic field is of sufficient strength to effect a bending or swaying or directing of the magnetic particle complexes. In an aspect the application of an magnetic field to the magnetic directable magnetic nanocrystal coated particles may be employed to direct the particles in a direction of choice prior to contact of the particles with a component of interest.

The strength of the magnetic field is expressed in units of Tesla abbreviated as T.

In a further aspect, a ligand having a sufficient affinity for that component of interest is determined and the ligand is attached to the magnetic oxide nanoparticle prior to contacting a component of interest.

Magnetic nanoparticles which may be suitably employed herein include, but are not limited to, magnetic iron alloys, iron oxides, rare earth metals, actinides, rare earth garnets, orthoferrides, ilmenites and spinal ferrites. Magnetic materials suitable for use as magnetic particle cores include, but are not limited to, magnetic iron, cobalt, manganese, nickel, cobalt, alnico, chromium, alloys of iron, cobalt, nickel, and manganese, rare earth metals, alloys of rare earth metals, actinide metals, alloys of actinide metals, spinel ferrites, rare earth garnets, platinum, palladium, orthoferrites, ilmenites, organic magnetic molecules, derivatives and combinations and thereof.

Nonlimiting examples of magnetic materials include, but are not limited to, cast or sintered neodymium-iron-boron, samarium-cobalt, Alnico such as aluminum-nickel-cobalt-iron, ferrite, derivatives and combinations thereof.

Examples of alloys of iron useful as magnetic nanoparticles include, but are not limited to, iron-aluminum, iron-carbon, iron-chromium, iron-cobalt, iron-nickel, iron nitride, iron phosphides, iron-silicon, iron-vanadium, halides of iron, borides of iron, sulphides of iron, iron-platinum and iron-palladium.

Examples of rare earth metals useful as magnetic nanoparticles include, but are not limited to, lanthanum, cerium, praseodymium, neodymium, promethium, samarium, europium, gadolinium, terbium, dysprosium, holmium, erbium, thulium, ytterbium, lutetium, yttrium and scandium.

Examples of useful actinide metals useful as magnetic nanoparticles include, but are not limited to, thorium, protactinium, neptunium, uranium, plutonium, americium, uranium.

Examples of rare earth garnets useful as magnetic nanoparticles include, but are not limited to, (Lo_{0.4}Y_{2.6})Fe₂Fe₃O₁₂, PrY₂Fe₂Fe₃O₂₂, Sm₃Fe₂Fe₃O₁₂, Y₃Fe₂Fe₃O₁₂, and Eu₃Fe₂Fe₃O₁₂.

Examples of orthoferrites useful as magnetic nanoparticles include, but are not limited to, LaFeO₃, LaCoO₃, YMnO₃, and SrCrO₃.

Examples of useful ilmenites useful as magnetic nanoparticles include, but are not limited to, MnTiO₃, FeTiO₃, and NiTiO₃.

Examples of magnetic organic molecules useful as magnetic nanoparticles include, but are not limited to 7,7,8,8-tetracyano-p-quinodimethane, and tetrathiafulvalenium tetracyanoqinomethane.

Examples of spinal ferrites useful as magnetic nanoparticles include, but are not limited to, magnetite, maghemite, manganese ferrite, cobalt ferrite, nickel ferrite, copper ferrite, magnesium ferrite, Co—Mg Ni ferrite, Co Zn ferrite, and Ni Zn ferrites.

Generally the coated nanoparticles have an overall diameter in the range from about 0.1 nanometers to about 1,000 nanometers and preferably from about 0.1 nanometers to about 200 nanometers and most preferably the coated nanoparticles have core diameter in the range from about 0.1 nanometers to about 100 nanometers. Typically, the size distribution is about ±10%.

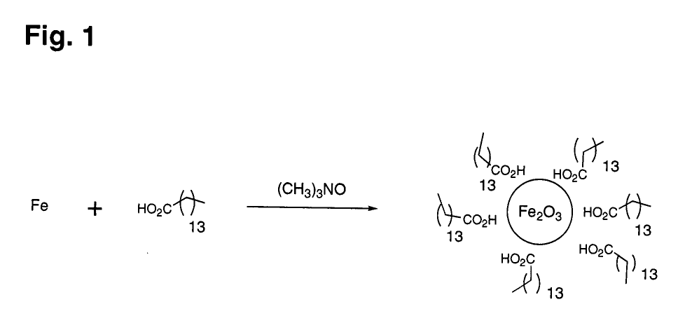

The present invention provides an oxidation process for producing magnetic iron oxide nanocrystals having a narrow size distribution of as low as ±10%. In this exemplary process (Example 1) (see FIG. 1), metal (0) is shown oxidized by an oxidant in the presence of largely excessive organic surfactant (for example, pentadecanoic acid as a ligand). This produces a surfactant coated magnetic iron oxide nanocrystal.

In an exemplary embodiment (Example 1), an oxidation process was carried out at a temperature in the range from about 100° C. to about 300° C. in an organic solvent and the solution was slowly cooled down to room temperature allowing the formation of the gamma crystallinity of the product. Due to the presence of organic surfactant, the magnetic nanoparticles show remarkable stability. Thermogravimetric analysis (TGA) shows that the product is stable until about 420° C. TEM (transmission electron microscopy) measurements confirmed a very narrow size distribution of the (formed) nanoparticles. The concentration and the ratio of Fe(0) and organic ligand were varied and, different sizes were produced. X-ray powder diffraction analysis confirmed the gamma crystallinity of the resulting surfactant coated magnetic iron oxide nanocrystal product.

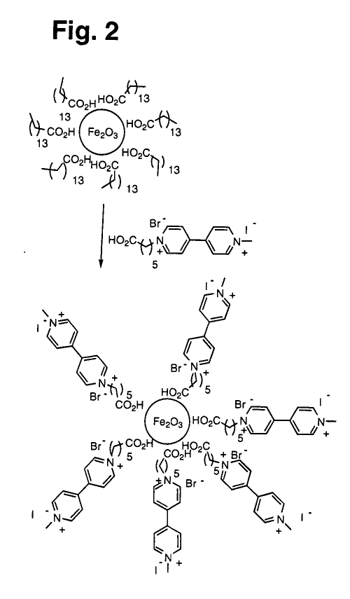

In an aspect, the physical absorption of the desired ligands onto the surfaces of the pre-formed magnetic nanoparticles is carried out as follows. An exemplary process is shown in Example 2 (FIG. 2), in which different functionalities were used to place-exchange existing protecting ligands on magnetic nanoparticles completely or partially. Under most process conditions, this ligand place exchange can maintain the dimension, size uniformity and crystallinity of a pre-formed magnetic particle(s) while place exchange introduces alternative ligands or molecules with suitable different functionalities for the formation of the magnetic compositions. The place-exchange process usually takes place in a solvent with the presence of replacing ligands or molecules which replace an original ligand.

Without limiting the scope of this invention, the phrase “place-exchange” includes a process wherein protecting ligands on the surfaces of magnetic oxide cores are replaced fully or partially in whole or part by different molecules or functionalities initially present in a surrounding composition.

In an aspect the surface of the magnetic particle is coated with a surfactant first and then fully or partially replaced with a successor ligand. Ligands usually have some sensitive functional groups that cannot tolerate the high temperature such as —OH is not recited in Example 1. For those instances wherein the appropriate ligands can tolerate oxidants and high temperature, the iron oxide nanoparticles can be coated with functional ligands directly. For example, in Example 3E, the inventor used N-Methyl-N′-(6-carboxylhexyl)-4,4′-bipyridinium iodide bromide salt ligand directly.

It is preferred to place exchange in by coating a magnetic oxide nanoparticle with surfactant initially and then replacing the surfactant with a ligand in a place exchange. This type of exchange is an exchange of one chemical moiety for another moiety. As used herein, an initial moiety is termed a precursor or replaced moiety and a replacement moiety is the successor moiety.

In an aspect a coating is applied directly to a magnetic iron oxide particle with sulfate directly as the sulfate can be used as surfactant directly as it does not contain a sensitive group on the other end. Thiol and alcohol are added as coating agent in a place exchange as directly coating of thiol and alcohol to the nanoparticle under process conditions of high temperature would cause the thiol and alcohol to be wastefully unnecessarily oxidized due to the presence of oxidants and high temperature under the conditions in Example 2.

In another aspect, this invention provides a method for the synthesis of the core/shell magnetic nanoparticles. An exemplary process is shown in Example 5, in which the surface-initiated polymerization reactions were used to form a shell of polymers on the surfaces of the inorganic cores. The synthesis could be in organic solvents, aqueous solutions and solvent-free systems.

As used herein the term “polymerization” includes the process of forming a high molecular mass from monomers and comprises condensation or step reaction polymerization and addition or chain reaction polymerization.

In condensation reactions, covalent bonds are rearranged in such a way that two monomers are connected. In such reactions, generally two monomer molecules with at least two functional groups combine and eliminate water (or other molecule) to form a polymer.

Addition polymerization is a chain reaction in which monomers with double bonds are converted to polymers. Initiation is the first step in addition polymerization in which a highly reactive species is generated, usually a free radical, cation or anion. Bulk polymerization, solution polymerization and emulsion polymerization are main forms of polymerization.

A polymerization process for forming a polymer useful as a coating for magnetic particles herein comprises effectively polymerizing monomer(s) in a monomer soluble composition of one or more polymerizable monomers.

Without limiting the scope of this invention, the term “monomers” and “polymerizable ligands” refer to any functionally linkable molecules that can be chemically linked either from the natural sources or made synthetically. Examples include, but are not limited to, styrene, acronitrile, acrylate, ethylene, methyl methacrylate, tetrafluoroethylene, propylene, ethylene epoxide, propylene epoxide, vinyl chloride, vinyl acetate, 1-vinylnaphtahlene, isobutene, isoprene, tetraethylorthosilicate and aminopropyltrimethoxysilane, amino acids such as D- and L-alanine, carbohydrate units such as D-Glucose, nucleic acids such as adenosine, their derivatives and combinations thereof.

The polymerization process may include the production of copolymers may be of any type. They may be any of random copolymers produced by addition polymerization, block copolymers, and the like. Further, there is no particular limitation on the copolymerization process, and any one of the solution polymerization process, the emulsion polymerization process and the like can be adopted to produce the copolymers.

Useful polymerization texts include Polypropylene Handbook: Polymerization, Characterization, Properties, Processing, Applications, Edward P., Jr. Moore (Editor)/Published 1996 Principles of Polymerization George G. Odian/Published 1991 Comprehensive Polymer Science: The Synthesis Characterization Reactions and Applications of Polymers: Chain Polymerization, Geoffrey C. Eastmond, et al/Published 1990. See also Ullmann's Encyclopedia of Industrial Chemistry Sixth Edition, June-2001 Electronic Release, Germany, Austria, Switzerland, WILEY-VC Verlag GmbH & Co. KgaA, Customer Service Dept., Postfach 10 11 61, D-69451 Weinheim, Federal Republic of Germany as published by John Wiley & Sons, Inc., Wiley InterScience Coordinator, Subscription Department, 111 River Street, Hoboken, N.J. 07030 U.S.A

In a situation involving a polymerization coating, in order to make an effective polymer coating, the ligand is an initiator. The ligand will reside on the surface of the coated magnetic particle. It is believe that the initiator will stay there while polymerizing the polymerizable monomers present in the surrounding solution or on the surfaces of nanoparticles. The initiator will induce a second layer of polymer on the top of or at the side of the initiators.

Without limiting the scope of this invention, the aforementioned surface-initiated polymerization methods include, but are not limited to, cationic polymerization and anionic polymerization, free radical polymerization including living free radical polymerization such as atom transfer radical polymerization and nitroxide-controlled polymerization. Without limiting the scope of this invention, examples of useful initiators include, but are not limited to, free radical initiators including peroxides and hydroperoxides such as benzoyl peroxide, halogen compounds such as 10-carboxydecanyl 2-bromo-2-methyl-thiopropanoate and 3-chloropropionic acid, azo compounds such as 2,2′-azobisisobutyronitrile, redox initiators such as cumyl hydroperoxide, photoinitiators such as benzoin, nitroxides such as 2,2,5-trimethyl-4-phenyl-3-azahexane-3-nitrode; cationic initiators such as AlCl₃ and triphenylmethyl halides; anionic initiators such as stilbene treated with sodium.

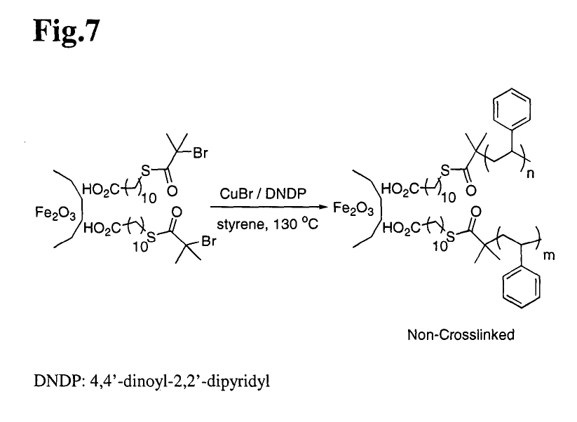

In an exemplary embodiment (Example 5B, see FIG. 7), without limiting the scope of this invention, the polymerization process was carried out first by placing-exchanging the free radical organic initiator (for example, 10-carboxydecanyl 2-bromo-2-methyl-thiopropanoate) onto the surfaces of the inorganic magnetic cores. The resulting nanoparticles were then treated with polymerizable organic ligands (for example, styrene in the presence of other reagents such as CuBr and 4,4′-dinoyl-2,2′-dipyridyl) at an elevated temperature of 135° C. The inorganic cores were confirmed by the transmission electron microscopy and the formation of the organic polymer coatings or shells were proved by the infrared spectroscopy, ¹H NMR and gel permeation chromatography (GPC) analyses after HCl dissolution of the Fe₂O₃ cores.

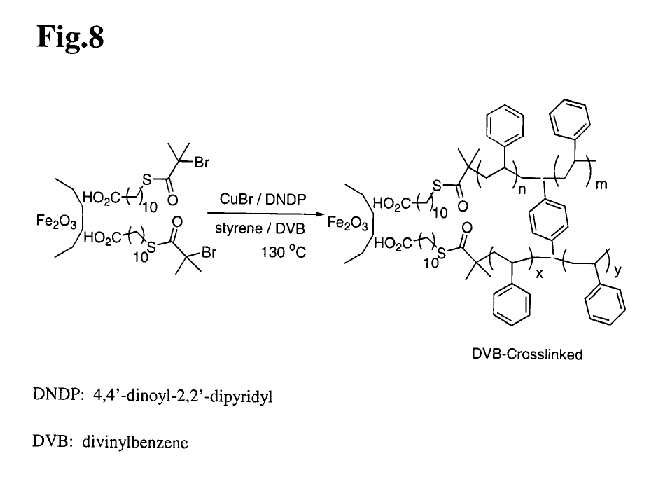

In yet another embodiment (Example 5C, see FIG. 8), without limiting the scope of this invention a crosslinking agent such as divinylbenzene was added with other polymerizable ligands such as styrene to form the crosslinked polymeric shells on the surfaces of inorganic cores in polymerization coating. The amount of the crosslinking agent could be varied and the crosslinking densities of the shell polymers could be varied by controlling the degree of the polymerization. The formation of the crosslinked polymeric shells were confirmed by the fluorescence experiments as shown in Example 5C.

In yet another embodiment (Example 5D), without limiting the scope of this invention, the aforementioned polymerization processes could be carried out in the absence of any solvents.

Without limiting the scope of this invention, the aforedescribed polymerization processes can be carried out in suspension, for example, suspending the polymerizable ligands in aqueous solutions.

Without limiting the scope of this invention, the aforementioned polymerization processes can be carried out in emulsion, for example, dispersing the monomers in the aqueous phase by an emulsifying agents such as a soap or detergent (e.g. sodium salt of stearic acid).

In a polymerization aspect when the initiator is not sufficiently stable under high temperature and oxidants under process conditions such as in Example 1 for the self-assembly synthesis of iron oxide nanoparticles, the inventor made iron oxide nanoparticles (alternatively purchase such particles, the commercial iron oxide nanoparticles are coated with surfactants, but have mixed crystallinity and large size distributions) coated with surfactants. Then the inventor partially replaced the surfactants with the initiator at room temperature. This process will form a coating of surfactants and initiators. Then, such compositions were added to a solution containing polymerizable monomers. Sufficiently raising the temperature or shining (applying) an effective amount of UV lights will initiate the initiator to launch the chain reaction to accumulate the polymers on the top of the initiator and surfactants.

In yet another situation involving a polymerization coating, in order to make an effective polymer coating, the ligand is selected that can lead to or induce the elongation of monomers. The ligand will reside on the surface of the coated magnetic particle. Without being bound by theory, it is believe that the initiator will remain on the surface on proximate thereto while initiating the polymerization of the polymerizable monomers present in the surrounding solution or on the surfaces of nanoparticles. Further it is believed that the ligand will induce a second layer of polymer on the top of or at the side of the initiators.

Without limiting the scope of this invention, the term “initiator ligand” refers to a chemical ligand moiety that can be converted to an initiator suitable and effective for the polymerization processes and/or can react with the polymerizable monomers present in the surrounding solution or on the surfaces of nanoparticles to form a high molecular mass from monomers and comprises condensation or step reaction polymerization and addition or chain reaction polymerization.

A nonlimiting example of a suitable effective ligand that can be converted to a free radical initiator is illustrated in Example 5G, in which the coating ligand 11-mercaptoundecanoic acid on the surfaces of nanoparticles were converted into the initiator 10-Carboxydecanyl 2-Bromo-2-methyl-thiopropanoate on the surfaces of nanoparticles for polymerization processes.

In yet another exemplary embodiment (Example 7), without limiting the scope of this invention, the aforementioned organic transformations for polymerization could be carried out on the surfaces of magnetic nanoparticles.

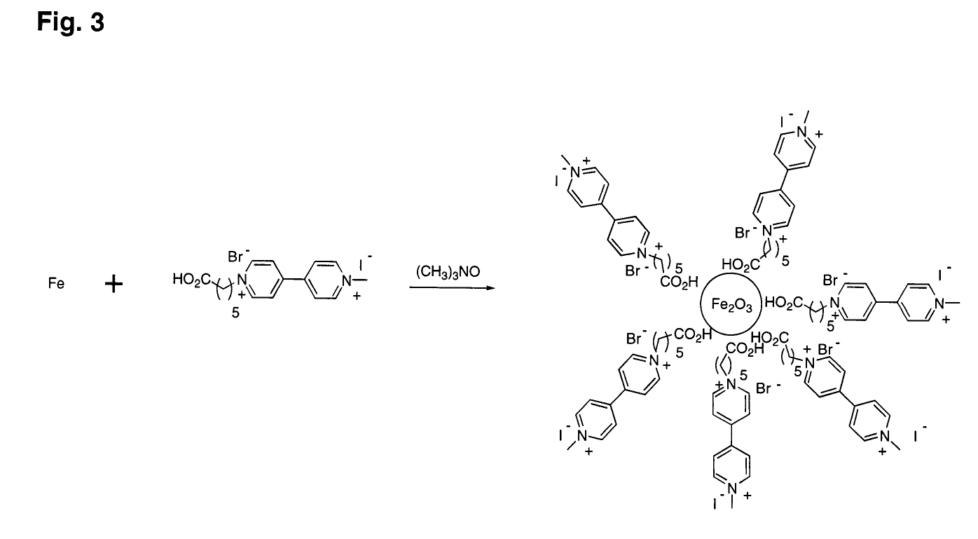

In an aspect, a water-soluble iron oxide magnetic nanoparticle composition is synthesized via an oxidation approach in the presence of water-soluble ligands. Illustratively, a water-soluble ligand N-methyl-N′-(6-carboxylhexyl)-4,4′-bipyridinium dibromide salt is used for this purpose. A synthetic protocol is similar to the process presented in Example 3E (FIG. 3).

Water-soluble magnetic compositions are prepared which have existing coating molecules on pre-formed magnetic particle compositions in contact with water-soluble ligands. A water-solubilizing layer is coated on the outer surface of magnetic compositions, as discussed in Example 3C (see FIG. 2). The synthesis of the product is achieved via physically absorbing water-soluble ligands onto the surfaces of pre-formed and coated metal particles. The place-exchange was carried out at room temperature with the presence of excessive water-soluble ligands. The detailed protocols are discussed in Example 3C.

In another embodiment, the present invention provides a composition comprising a magnetic particle and is associated with a molecule or molecular complex that can interact with inorganic substances. The interaction can be direct and indirect. In carrying out such interaction, the magnetic particle is positioned in contact or in sufficiently close proximity to the inorganic particle such as to induce the successful desired interaction. Nonlimiting illustrative useful inorganic substances include heavy metals, rare-earth metals, metal oxide, metals and their derivatives and combinations thereof. Without limiting this invention, the inorganic substances could be from either natural sources, such as native minerals, or wastes, such as industrial, nuclear wastes.

Nonlimiting examples of useful heavy metals include mercury, cobalt, uranium. The example of heavy metals also include, but are not limited to, radioactive uranium, radioactive plutonium, Cobalt-60, iridium-192, cesium-137 and Strontium-90.

Nonlimiting examples of useful inorganic substances include cyanides such as sodium cyanide and potassium cyanide.

Nonlimiting examples of useful minerals include gold, tin, silver, platinum, palladium, copper, lead and zinc.

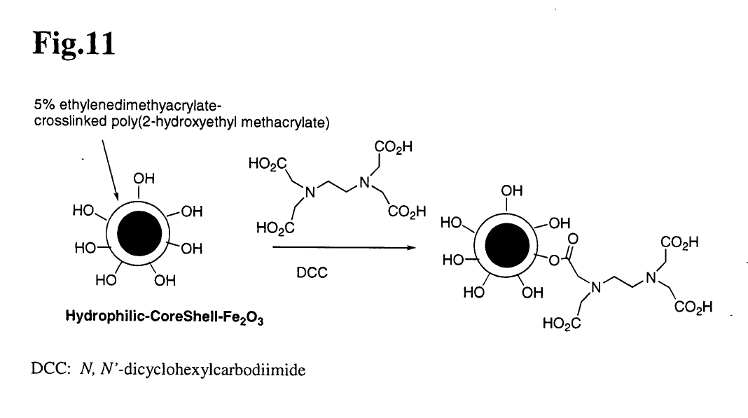

Without limiting the scope of this invention, an exemplary synthesis of the aforementioned composition was discussed in Example 5F (see FIG. 11), in which ethylenediaminetetracetic acid was chemically linked to the surfaces of 5% ethylenedimethacrylate-crosslinked poly(2-hydroxyethyl methacrylate). Ethylenediaminetetracetic acid is a chelating agent for many metal ions. An exemplary application of using such a composition was discussed in Example 6 for the removal of Pb²⁺ ions.

Use of the present invention for interaction with heavy metals, rare-earth metals, metal oxide, metals and their derivatives involves a process of analyzing the characteristics of the heavy metals, rare-earth metals, metal oxide, metals and their derivatives and chemical composition to be treated, identifying a functional moiety which will react with and affix to a desired component to be separated or recovered from that composition, preparing a coating for a magnetic nanoparticle which has an affinity for that heavy metals, rare-earth metals, metal oxide, metals and their derivatives and component, admixing that coated magnetic nanoparticle with the composition to be treated. In a further aspect the composition is further refined by admixing the coated particle with the composition and removing the coated particles which are bound to the heavy metals, rare-earth metals, metal oxide, metals and their derivatives.

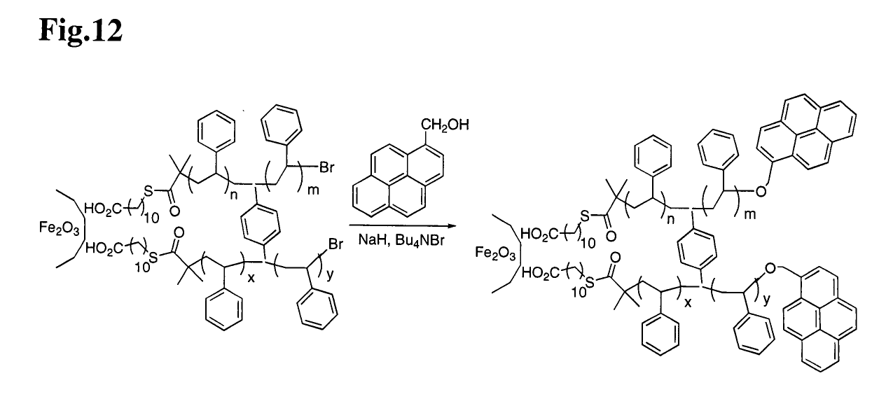

In another embodiment, a composition is provided comprising a coated magnetic particle and is associated with a molecule or molecule complex that can interact with organic substances. The interaction can be direct and indirect. Useful organic substances, without limiting the scope of this invention, include small organic molecules, organic-metallic complexes, organic materials such as polymers, etc. Examples of organic substances include benzene and acrylic acid. A nonlimiting example is shown in Example 7 (see FIG. 12), in which the terminal bromine atom of the core/shell polystyrene/Fe₂O₃ nanoparticles can react with 1-pyrenemethanol in the presence of sodium hydride.

Use of the present invention for interaction with small organic molecules, organic-metallic complexes, organic materials such as polymers such as benzene and acrylic acid includes a process of analyzing the characteristics of small organic molecules, organic-metallic complexes, organic materials such as polymers such as benzene and acrylic acid in the chemical composition to be treated, identifying a functional moiety which will react with and affix to a desired component to be separated or recovered from that composition, preparing a coating for a magnetic nanoparticle which has an affinity for that desired component coating the article, admixing that coated magnetic nanoparticle with the composition tot be treated. In a further aspect the composition is further refined by admixing the coated particle with the composition and effectively removing the coated particles which are bound to small organic molecules, organic-metallic complexes, organic materials such as polymers such as benzene and acrylic acid from the admixed composition.

In another embodiment, a composition is provided comprising a magnetic particle and is associated with a molecule, or molecular complexes or a functional group that can be utilized as a platform for organic, physical and biological transformations and for separating, isolating and purifying reagents, catalysts, scavengers, byproducts, intermediates and final products.

Use of the present invention as a platform for interaction with organic, physical and biological transformations and for separating, isolating and purifying reagents, catalysts, scavengers, byproducts, intermediates and final products includes a process of analyzing the characteristics of organic, physical and biological transformations and for separating, isolating and purifying reagents, catalysts, scavengers, byproducts, intermediates and final products in the chemical composition to be treated, identifying a functional moiety which will react with and affix to a desired component to be separated or recovered from that composition, preparing a coating for a magnetic nanoparticle which has an affinity for that desired component, admixing that coated magnetic nanoparticle with the composition to be treated.

A nonlimiting example is shown in Example 7 (FIG. 12), in which a replacement reaction can take place at the surfaces of the nanoparticles. The 10% divinylbenzene-crosslinked polystyrene shell covering the Fe₂O₃ cores was achieved by the atom transfer radical polymerization (see Example 5C, FIG. 8) and the termini of the polymers had a bromine atom. Such —Br was replaced by the sodium salt of 1-pyrenemethanol. Fluorescence examinations of the organic shells after HCl dissolution of the Fe₂O₃ cores confirmed that the divinylbenzene-crosslinked polystyrene polymers have been labeled with the pyrene chromophores. Similar processes in Example 5C using 6-(1-pyrenyl)hexanoic acid ruled out the possibility of a place-exchange reaction.

In yet another nonlimiting example (see Example 11), a chiral catalyst (R)—Bi-2-naphthol was attached to the 10% divinylbenzene-crosslinked polystyrene via a replacement reaction. The nanoparticle-supported catalyst was used to promote a Diels-Alder reaction. After reaction, the catalyst was removed out of the reaction mixtures.

In yet another embodiment, a composition is provided comprising a magnetic particle and is associated with a molecule, or molecular complexes or a functional group that can be utilized as a platform that are soluble in the reaction media for organic, physical and biological transformations and for separating, separating, isolating and purifying reagents, catalysts, scavengers, byproducts, intermediates and final products. A nonlimiting example is shown in Example 7, in which the core/shell polystyrene/Fe₂O₃ nanoparticles that can react with 1-pyrenemethanol in the presence of sodium hydride are soluble in toluene.

In another embodiment, a composition is provided comprising a coated magnetic particle and is associated with a molecule, or molecular complexes or a functional group that can be utilized as a platform for the high-throughput combinatorial syntheses and for separating, isolating and purifying reagents, catalysts, scavengers, byproducts, intermediates and final products during the combinatorial syntheses. In this aspect a coating is selected which has an affinity for reagents, catalysts, scavengers, byproducts, intermediates and final products of a combinatorial syntheses. In an aspect a coating is prepared which has this desired affinity and is affixed to a magnetic nanoparticle. The coated nanoparticle is admixed with a composition derived from or a part of a combinatorial syntheses and effective contact is made with the composition. After an effective amount of time, the coated particle is removed or otherwise separated from the composition and the coated particle is thereafter refined to provide the refined or purified reagent, catalyst, scavenger, byproduct, intermediate and final product.

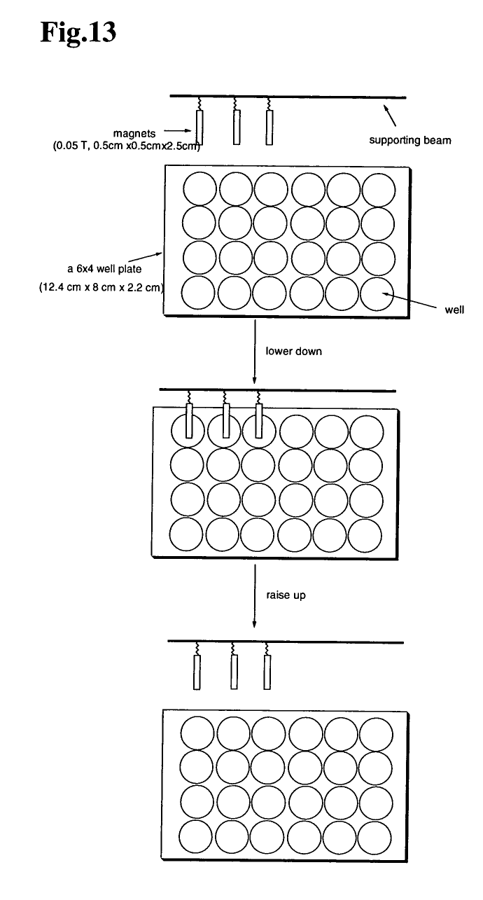

A nonlimiting example in Example 8 (see FIG. 13) shows that three rectangular 0.05 T (Tesla) magnetic pins fixed on a long beam can be used to remove the magnetic nanoparticles from three different wells simultaneously, providing the potential for the high-throughput separating, isolating and purifying reagents, catalysts, scavengers, byproducts, intermediates and final products anchored on the surfaces of magnetic nanoparticles.

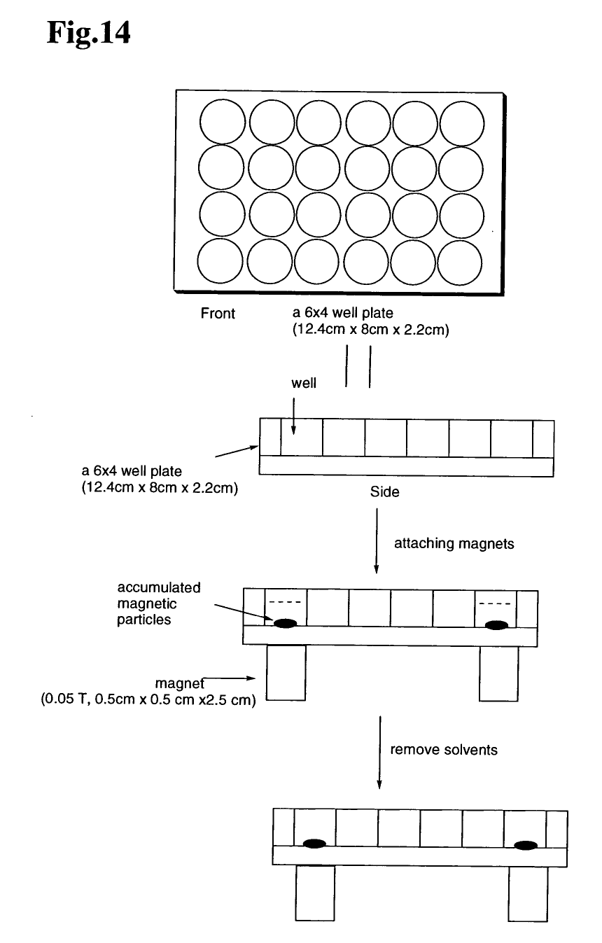

In yet another nonlimiting example in Example 9 (see FIG. 14), two magnetic pins (0.5 T) were placed under two wells of a multiple well plate for the simultaneous concentration of magnetic nanoparticles, providing the potential for the high-throughput separating, isolating and purifying reagents, catalysts, scavengers, byproducts, intermediates and final products anchored on the surfaces of magnetic nanoparticles.

In another embodiment, a composition is provided comprising a magnetic particle and is associated with a molecule(s), or molecular complex(es) or a functional group(s) that can be utilized as a platform for hosting target molecules for the high-throughput combinatorial assays.

In another embodiment, a composition is provided comprising a magnetic nanoparticle and is associated with a molecule(s), or molecular complex(es) or a functional group(s) that can be utilized as a platform that are soluble in the assay media for hosting target molecules for combinatorial assays. An nonlimiting example is Example 8, in which the superparamagnetic nanoparticles used in the experiment are coated with N-Methyl-N′-(6-Carboxylhexyl)-4,4′-Bipyridinium Iodide Bromide Salt. Such nanoparticles are soluble in water and can be removed from three wells on a multi-well plate using a magnetic array.

Illustrative non-limiting useful transformations include peptide synthesis, nucleic acid synthesis, peptidomimetic synthesis, combinatorial library synthesis, small molecule synthesis, carbohydrate synthesis, biosynthesis of organic, biological molecules, and combinations thereof.

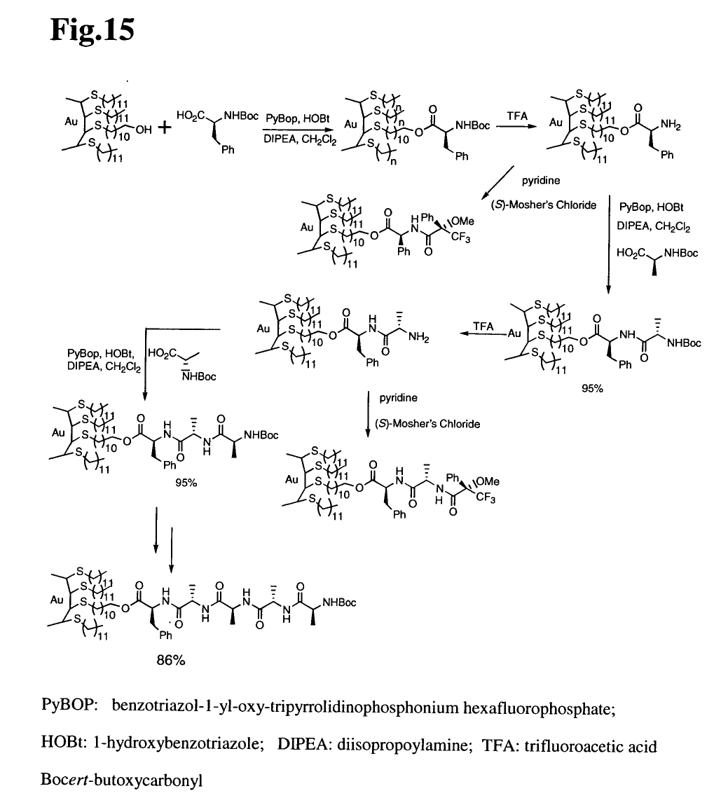

A nonlimiting example of peptide synthesis is listed in Example 10 (see FIG. 15), in which a pentapeptide phenylalaine-alanine-alanine-alalnine-alanine were synthesized by sequentially removing the N-protecting group and the peptide elongation with 1-hydroxybenzotriazole and benzotriazol-1-yl-oxy-tripyrrolidinophosphonium hexafluorophosphate in the presence of diisopropoylamine.

A nonlimiting example of nucleic acid synthesis is the synthesis of A-G-A using the polystyrene supports via sequentially removing the protecting groups followed by the addition of the nucleic acids of A, G and A sequentially.

A nonlimiting example of peptidomimetic synthesis is to synthesize 3-(3′-aminoethylcarboxy)aminopropanoic acid from two molecules of 3-aminopropanoic acid.

A nonlimiting example of a combinatorial library synthesis is to form a small library of three different peptide sequences. These sequences are phenylalanine-alanine-alanine, alanine-alanine-alanine and tryptophan-alanine-glycine. Three peptides could be synthesized in three different wells or combined in one vessel in solution or linked to the polystyrene beads.

Without limiting the scope of this invention, examples for the synthesis of small molecules are illustratively depicted in Examples 7 and 11, in which the replacement reaction and a Diels-Alder product were formed.

A nonlimiting example of the carbohydrate synthesis is to hydrolyze α-D-Sucrose with aqueous HCl solution to yield D-Glucose.

A nonlimiting example of the biosynthesis of biological compounds is to use Diaminopimelate Decarboxylase to covert meso-diaminopimelate to L-lysine.

A nonlimiting example of the biosynthesis of organic molecules is to use β-Galactosidase to convert O-nitrophenyl-β,D-galactopyranoside to galactose.

Another aspect of this invention includes the use of magnetic nanoparticles, especially water-soluble nanoparticles for therapeutical uses. Without limiting the scope of this invention, this includes the removal of harmful substances from blood circulation using magnetic particles. Examples of such harmful substances include digoxin toxin, excessive cholesterol, for example magnetic compositions linked with anti-digoxin antibodies. (Digoxin is a toxin that causes damage to biological systems by chemical means).

In an aspect a coated magnetic composition having an outer coating which has an affinity for digoxin is incubated with blood streams in a living patient. After incubating coated magnetic compositions with blood streams sufficient and effectively in vitro, external magnetic fields can be applied and utilized to remove complexes of anti-digoxin antibodies and digoxin linked to magnetic compositions. In this way an appropriate magnetic field is applied to the blood stream or sample thereof. The removal proceeds by the removal of magnetic compositions induced by the applied magnetic field from the circulating vascular system of a living mammal such as a human. Such complex may be directed or routed to a particular removal system by action of the applied magnetic field. In an aspect such removed compositions comprise excessive amounts of anti-digoxin toxin. These are removed, for example from the blood circulation system for example in an extra-corporeal blood circulation and return system to a living mammal patient. In an aspect an online extra-corporeal blood filter is employed to selectively retain magnetic particles complexes with compositions to be removed. These may be selectively removed in a system which involves using a magnetic field to direct or provide direction to the magnetic particles complex by application of a magnetic field to the magnetic particle complex resulting in a retention of the particles and subsequent removal. In an aspect the patient is a living human.

It is understood that the effective application of a magnetic field is generally universal such as from a permanent magnet, that an effective portion of the magnetic field is applied omni-directional to the magnetic particles. It is further understood that the magnetic field strength is applied which takes into account operating factors including the distance of the magnet to the desired target magnetic particles among other operational factors.

Yet another aspect of this invention includes the use of magnetic nanoparticles for detecting, sorting, labeling, removing and separating organic and/or inorganic substances from their environments. Without limiting the scope of this invention, an example is to use magnetic compositions to chelate and/or absorb radioactive metals such as cobalt from nuclear waste. Magnetic particles and compositions have high surface areas accessible to radioactive cobalt, and ligands associated with magnetic particles can chelate or attract cobalt metal. External magnetic forces will then be used to attract/pull/retrieve radioactive materials out of the wastes. An advantage of using magnetic compositions is that the whole process can be potentially carried out by equipment in the absence of human operators i.e. a non human operation (automatic or automated). A nonlimiting example is shown in Example 6, in which the core/shell Fe₂O₃ nanoparticles coated with ethylenediaminetetracetic acid were used to remove Pb²⁺.

In another embodiment, this invention includes the use of magnetic nanoparticles as supports for carrying out chemical, physical and biological transformations and for separating, isolating and purifying unreacted/spent reagents, catalysts, scavengers, byproducts, reaction intermediates and products. Nonlimiting examples are shown in Examples 7 and 10, in which nanoparticles were used for the replacement reaction and the peptide synthesis, respectively. Advantageously these uses provide a recovery or processing model for chemical and/or biotechnical discrimination of unstructured bioprocess product and byproduct compositions, control of fermentation processes and waste water treatment plants.

A nonlimiting example is shown in Example 7 (FIG. 12), in which a replacement reaction can take place at the surfaces of the nanoparticles. The 10% divinylbenzene-crosslinked polystyrene shell covering the Fe₂O₃ cores was achieved by the atom transfer radical polymerization (see Example 5C, FIG. 8) and the termini of the polymers had a bromine atom. Such —Br was replaced by the sodium salt of 1-pyrenemethanol. Fluorescence examinations of the organic shells after HCl dissolution of the Fe₂O₃ cores confirmed that the divinylbenzene-crosslinked polystyrene polymers have been labeled with the pyrene chromophores.

As used herein the term “chemical transformations” include without limitation, small molecule synthesis, peptide and nucleotide synthesis, carbohydrate synthesis and inorganic materials reactions.

Biological transformations include those transformations converting substrates into products by the action of enzymes and inhibiting enzymes with inhibitors.

A magnetic nanoparticle mediated biological transformation herein also includes delivery and introduction of exogenous ligand DNA molecules which are coated onto magnetic particles that are propelled into target cellular tissues by cellular useful transformation propulsion and projectile methods.

In an aspect transformation is carried out by contacting a composition containing ligand DNA molecules as a coating on a coated magnetic oxide particle desired to be transformed into living mammalian cellular tissue. This is accomplished using a coated magnetic particle having an initial coat which is place exchangeable with capably encoding DNA thus forming a coated magnetic particle DNA molecule complex. In an option ligand DNA (deoxyribonucleic acid) is coated directly on the magnetic oxide particle using the inventive process herein. The DNA molecule ligand complex would be direct transferred into isolated protoplasts using a projection system accommodating the DNA coated magnetic particle complex. Useful projection systems include a microprojectile mediated DNA projectile delivery system such as a gene gun. A new cell phenotype (trait) would be created.

In one aspect the present invention provides a method of transforming a plant cell or plant tissue with molecular capable encoding DNA by competently inoculating a transformable cell or tissue containing at least one genetic component capable of being transferred to a plant cell or tissue, selecting a transformed plant cell or tissue, injecting a ligand DNA magnetic oxide nanoparticle complex and regenerating a transformed plant expressing the genetic component from the inoculated plant cells or tissue.

In another embodiment, this invention includes the use of magnetic nanoparticles as supports for carrying out the high-throughput combinatorial library synthesis and target molecule screening. A nonlimiting example of a combinatorial library synthesis is to form a small library of three different peptide sequences. These sequences are phenylalanine-alanine-alanine, alanine-alanine-alanine and tryptophan-alanine-glycine. Three peptides could be synthesized in three different wells or combined in one vessel in solution or linked to the polystyrene beads. In an aspect compositions in the well(s) would be contacted with a magnetic particle having a coating which has an affinity for the peptide sequences. After sufficient contact time has elapsed, the magnetic particle peptide complexes can be directed by action of an effective applied magnetic field to a recovery area for their subsequent recovery. A nonlimiting example in Example 8 (see FIG. 13) shows that three rectangular 0.05 T magnetic pins were fixed on a long beam can be used to remove the magnetic nanoparticles from three different wells simultaneously,

In another embodiment, this invention provides a method for the high-throughput separating, isolating and purifying of magnetic nanoparticle-supported reagents, catalysts, scavengers, intermediates and products. A magnetic array equipped with multiple permanent or electromagnetic magnets removes magnetic particles from multiple-wells on the plates. An exemplary process is shown in example 8 (FIG. 13), in which magnetic pins were used to remove magnetic nanoparticles from multiple wells on the plate simultaneously. (Three rectangular 0.05 T (Tesla) magnetic pins were fixed on a long beam were lowered down and dipped into three corresponding small wells containing the aqueous solutions of iron oxide nanoparticles coated with N-Methyl-N′-(6-Carboxylhexyl)-4,4′-Bipyridinium Iodide Bromide Salt. After 10 minutes, the beam was raised up and the magnets were removed out of three wells. Magnetic nanoparticles were found to accumulate on the surfaces of magnets, which had contact with the aqueous solutions.

In yet another embodiment, this invention provides a method for the high-throughput separating, isolating and purifying of magnetic nanoparticle-supported reagents, catalysts, scavengers, byproducts, intermediates and products. In an aspect in high-throughput screening, magnetic fields are applied to the surrounding areas of the wells on the plate to retain magnetic composites which have been selective chosen for their affinities of a coating toward compounds undergoing screen. A determination can be made on the basis of whether a compound is retained by a coated magnetic particle which will provide the basis for advancing that compound in a screen or not. In an aspect this aspect comprises a screening tool and research tool. Solvents and other reaction mixtures are removed out of the wells. An exemplary process is shown in Example 9 (FIG. 14), in which the localized magnetic fields were used to separate magnetic nanoparticles from mixtures from multiple wells on the plate simultaneously.

A nonlimiting example of reagents is N,N′-dicyclohexylcarbodiimide that can couple phenylalanine and alanine. A nonlimiting example of catalysts is listed in Example 11 as (R)—Bi-2-naphthol complexed with diisopropoxytitanium chloride to promote a Diels-Alder reaction.

A nonlimiting example of scavengers is polystyrene-supported piperazine that can neutralize and remove H⁺ from the reaction mixtures.

In another embodiment, this invention provides methods for the automated organic, library synthesis and library screening, in which magnetic nanoparticles are used as supports for hosting reagents, catalysts, scavengers, intermediates and products. The removal of these supports and their associated molecules are achieved by using magnetic arrays, or magnets or fields. The addition and removal of magnetic supports and associated molecules are controlled by human operators or computer programs

The hosting method of the present invention includes analyzing the characteristics of the biocomposition or chemical composition to be hosted, identifying a functional moiety which will react with and affix to a desired component to be hosted, preparing a coating for a magnetic nanoparticle which has an affinity for that component to be hosted, and admixing that coated magnetic nanoparticle with the composition to be hosted.

Another aspect of this invention includes the aforementioned uses and methods of a magnetic composition comprising of a magnetic particle protected with layers of coating materials and associated with a molecule and molecular complexes. The coating materials include, but are not limited to, organic polymers including the crosslinked polymers either synthesized in the laboratory or found in nature, silica and small organic molecules. Without limiting the scope of this invention, an example is illustrated in FIG. 11. The ability of the coated magnetic composition to deliberately discriminate and selectively remove the desired component to be removed is thus advantageously employed using this invention.

Still another aspect of this invention includes the herein recited uses and methods of water-soluble magnetic nanoparticles and magnetic compositions.

In another aspect, coated magnetic particles having a particle size in the range from about 0.1 nm to about 1000 nm are employed in platforms, hosting, magnetic separations, labeling, removing, detecting, therapeutic uses, recombinant technology, high throughput screening and the like. In such uses the particle size distribution can be higher than ±10% but can be as low as ±10%.

A further aspect of this invention includes the aforementioned uses and methods of magnetic nanoparticles are employed.

Methods are discussed below in order to highlight the advantages and utilities of the inventive magnetic particles and their compositions. These methods, include but are not limited to, labeling, detecting, sorting, removing and separating a biological molecule, an inorganic substance and an organic substance, therapeutical uses, and the supports for chemical transformations.

The treatment method of the present invention includes analyzing the characteristics of the biocomposition or chemical composition to be treated, identifying and determining (selecting) a functional moiety which will react with and affix to a desired component to be separated or recovered from that composition, preparing a coating for a magnetic nanoparticle which has an affinity for that component, admixing that coated magnetic nanoparticle with the composition to be treated. In a further aspect the composition is further refined by admixing the coated particle with the composition and removing the coated particle in such a magnetic separation process.

Magnetic particles, especially those in the nanometer regime have attractive physical properties such as very high surface area, relatively small size and magnetic properties. Magnetic compositions comprising a magnetic core associated with functional groups or molecules have application potentialities and provide solutions to a variety of problems in chemistry, biology and medicine. For example, anti-digoxin antibodies attached to a water-soluble iron oxide composition could be dispersed into the blood of intoxicated animals in vitro, and applying external magnetic forces thereto will remove toxic digoxin that is bound to the iron oxide nanoparticles via the antibody-antigen interactions out of the blood.

A nonlimiting example of the use of the inventive magnetic compositions is to use magnetic compositions linked with anti-digoxin antibodies for the magnetic separation and removal of toxic digoxin, providing a viable alternative to activated charcoal and ion exchange resins. Water-soluble magnetic nanocompositions are preferred. After incubating magnetic compositions with blood streams in vitro, external magnetic fields can be utilized to remove the complexes of anti-digoxin antibodies and digoxin linked to magnetic compositions. This approach will minimize the loss of red blood cells, white blood cells and platelets from patients.

Polystyrene polymer beads are the support of present choice for carrying out organic reactions, such as peptide and combinatorial synthesis. The purification and isolation of the intermediates and final products can be carried out easily by simply filtering the solid phase out. However, due to heterogeneous nature of the polymer supports in organic solvents, reaction rates and yields could be limited by the pore sizes of the polymer supports and the rate of distributing reagents in and out of the pores of the polymer supports.

Magnetic nano-compositions will be utilized as an alternative to polystyrene polymer beads. The reactions carried out on the surfaces of nanoparticles are carried out under homogeneous conditions since most of magnetic nano-compositions could be dissolved in certain organic solvents. After reaction, external effective amounts of applied magnetic forces could be utilized to attract and isolate unreacted/spent reagents, catalysts, byproducts, scavengers, intermediates or products linked to the magnetic compositions. An example is illustrated in FIG. 12, in which a replacement reaction is carried out on the surfaces of a magnetic composition. The isolation of purification of the product are facilitated with the assistance of external magnetic fields using such a magnetic separation process.

Exemplary embodiments of the invention are described in the following examples. Other alternative embodiments within the scope of the claims herein will be apparent to one skilled in the art from consideration of the specification or practice of the invention as disclosed herein. It is intended that the specification, together with the examples, be considered exemplary only, with the scope and spirit of the invention being indicated by the claims which follow the Examples.

### EXAMPLES

All the chemicals mentioned below were purchased from Aldrich (Milwaukee, Wis.) or Acros Organics (Pittsburgh, Pa.) and used as received. Organic solvents were obtained from Acros Organics. Water was obtained from a Milli-Q reagent water system purchased from Millipore Corporation (Milford, Mass.). The permanent magnets were purchased from Dexter Magnetic Technologies Inc. (Elk Grove Village, Ill.). Core sizes were made form 3 nm to 89 nm with ±10% error.

### Example 1

### Preparation of Pentadecanoic Acid-Capped γ-Fe₂O₃ Nanocrystals (FIG. 1)

The in-situ preparation of pentadecanoic acid-capped γ-Fe₂O₃ nanocrystals as an example of coated magnetic nanoparticle iron oxide crystal follows.

Pentadecanoic acid (278.7 mg) was dissolved in 3 mL of octyl ether and the resulting solution was heated to 100° C. under Argon protection. Then 0.05 mL of Fe(CO)₅ (iron pentacarbonyl) was added into the aforementioned solution. The mixture was heated to reflux and kept at this temperature for 1 h. The solution was then gradually cooled down to room temperature and trimethylamine-N-oxide (85 mg) was added. The mixture was then heated to 130° C. under Ar protection and maintained at this temperature for 2 h. The solution was then brought to reflux. After 1 h, the solution was slowly cooled down to room temperature and 100 mL of ethanol was added. The black residues were separated by centrifugation (15,000×G, 30 min). The obtained powders could be re-dissolved in methylene chloride solution, and further purified by adding polar solvents like ethanol and acetonitrile followed by centrifugation (15,000×G, 30 min). A typical yield of 160 mg can be achieved via this approach.

These coated product nanocrystals were found to have a very uniform size distribution with an average core dimension of about 11 nm, determined by high-resolution TEM (transmission electron microscopy) measurements.

### Example 2

### Synthesis of Fe₂O₃ Nanoparticles Coated with Functionalities of Ligands Thiol, Alcohol, and Sulfonate Respectively

(a) Part (a) illustrates preparation of γ-Fe₂O₃ Nanoclusters surfactant coated with undecanethiol using place-exchange of pentadecanoic acid with undecanethiol

To a stirred solution of γ-Fe₂O₃ nanoparticles coated with pentadecanoic acid (30 mg) in 30 mL of chloroform was added 1.0 g of undecanethiol. The resulting solution was stirred under Argon protection at room temperature for 24 h, and 80 mL of ethanol was added. Black residues were separated via centrifugation (15,000×G, 30 minutes), and further purified by washing with ethanol (80 mL×3).

The chemical composition surrounding Fe₂O₃ cores was analyzed with spectroscopy methods after NaCN etching. The NaCN extraction of Fe₂O₃ was carried out by treating 18 mg of the above product in 20 mL of chloroform with NaCN (22 mg) in 10 mL of de-ionized water. The resulting mixture was stirred at room temperature for 48 h. The organic phase was then separated from aqueous layer, and dried over anhydrous Na₂SO₄. The solvent was removed in vacuo and the residue was examined by thin layer chromatography (TLC) and ¹H NMR spectroscopy. Undecanethiol was the only material identified in the analyses, suggesting the complete place-exchange of pentadecanoic acid with undecanethiol in the aforementioned replacement reaction.

(b) Part (b) illustrates preparation of Fe₂O₃ Nanoparticles Coated with Octanol.

A solution of γ-Fe₂O₃ nanoparticles surrounded with pentadecanoic acid (30 mg) and octanol (0.827 mL) in 10 mL of octyl ether was heated to 150° C. under Ar. (Argon) This temperature was maintained for 48 h, and 80 mL of ethanol was added. After centrifugation (15,000×G, 30 min), the resulting black precipitates were isolated and washed several times with acetonitrile. Octanol was found to be the only type of ligands for protecting the synthesized Fe₂O₃ nanoclusters after NaCN etching of Fe₂O₃ cores followed by spectroscopy analysis.

(c) Part (c) illustrates the preparation of Fe₂O₃ Nanoparticles Protected with Decanesulfonic Acid.

Decanesulfonic acid (185.7 mg) in octyl ether (4 mL) was heated to 100° C. under Ar protection. After the solution was cooled down to room temperature, Fe(CO)₅ (33.3 μL) was added and the resulting solution was brought to reflux. After 1 h, the solution was cooled down to room temperature again, trimethylamine-N-oxide (56.7 mg) was added. The mixture was heated to 130° C. and this temperature was maintained for 2 h. The solution was then brought to reflux and was slowly cooled down to room temperature again. Ethanol (80 mL) was added and the centrifugation process (15,000×G, 30 min) was employed to precipitate the black product. The residues were washed three times with ethanol (80 mL) and air-dried.

### Example 3

### Example 3 Shows the Preparation of Water Soluble Fe₂O₃ Magnetic Nanoparticles Coated with Ligand N-Methyl-N′-(6-Carboxylhexyl)-4,4′-Bipyridinium Iodide Bromide Salt

### A. Preparation of N-Methyl-4,4′-Bippyridinium Iodide

A solution of methyl iodide (2.48 mL) and 4,4′-bypyridine (7.08 g) in 200 mL of acetone was brought to reflux. After 3 hours, the solution was cooled down to room temperature. A precipitate formed which was collected and washed with acetone three times to remove unreacted starting materials.

A compound in the precipitate was analyzed by ¹H NMR (300 MHz, D₂O). The following NMR data was obtained: δ 8.72 (d, 2H), 8.58 (d, 2H), 8.20 (d, 2H), 7.71 (d, 2H), 4.22 (s, 3H). Mass spectroscopic analysis gave an m/z at 162 [M+1]⁺.

### B. Synthesis of N-Methyl-N′-(6-Carboxylhexyl)-4,4′-Bipyridinium Iodide Bromide

6-Bromohexanoic acid (60 mg) was reacted with N-methyl-4,4′-bipyridinium iodide (prepared as discussed immediately above) at a 1:1 molar ratio in DMF (40 mL) under Ar for 36 h at 120° C. DMF was then removed in vacuo and the residues were washed with acetonitrile (20 mL) three times. The product was characterized with ¹H NMR (300 MHz, D₂O): δ 8.95 (d, 2H), 8.90 (d, 2H), 8.42-8.37 (m, 4H), 4.35 (s, 3H), 2.22 (t, 2H), 1.96 (t, 2H), 1.60-1.21 (m, 6H). Mass spectroscopic analysis gave an M/2 peak at 127.

### C. Formation of Water-Soluble Fe₂O₃ Nanoparticles (FIG. 2) coated with ligand N-Methyl-N′-(6-Carboxylhexyl)-4,4′-Bipyridinium Iodide Bromide Salt

N-Methyl-N′-(6-carboxylhexyl)-4,4′-bipyridinium iodide bromide salt (200 mg) prepared as discussed immediately above, was dissolved in 20 mL of water, and a solution of Fe₂O₃ nanoparticles protected with pentadecanoic acid in chloroform (10 mL) was added. The resulting mixture was stirred vigorously at room temperature for 168 hours. The aqueous phase was separated from organic phase, and water was removed in vacuo to give the product. This product could be dissolved in aqueous solution, and transmission electron microscopy (TEM) analysis suggested that the product is very uniform nanometer-sized with an average core dimension of 11 nm.

### D. Preparation of a Water-Soluble Fe₂O₃ Nanoparticles Coated with Ligand Biotin

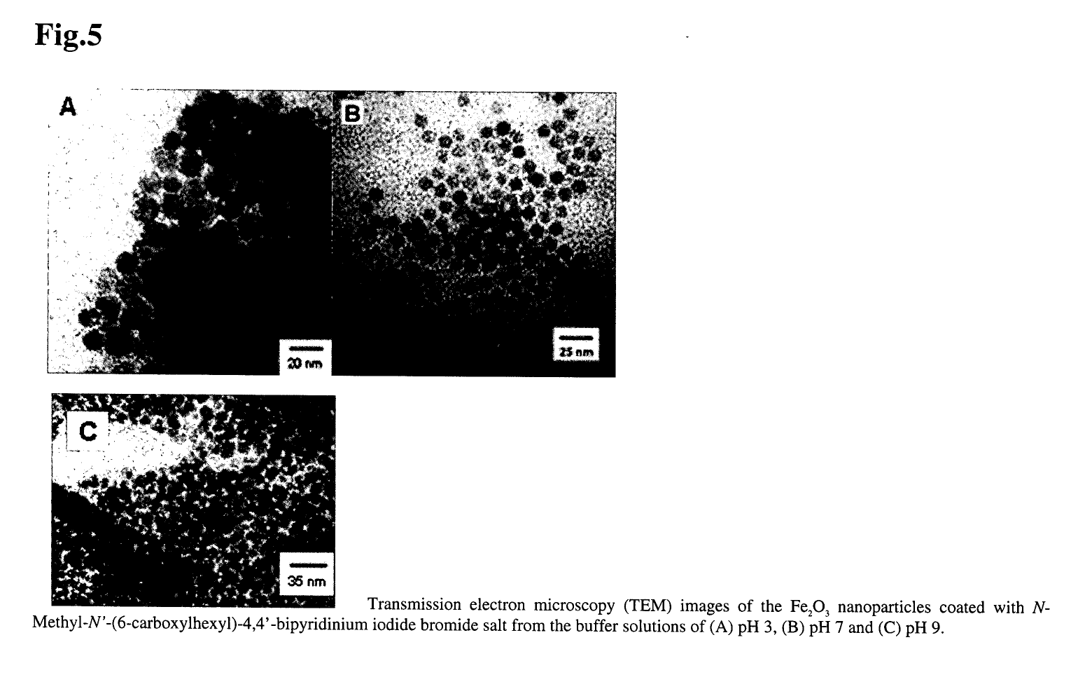

A solution of magnetic Fe₂O₃ nanoparticles coated with N-Methyl-N′-(6-carboxylhexyl)-4,4′-bipyridinium iodide bromide salt (30 mg) (prepared as discussed immediately above) and d-(+)-Biotin ammonium salt (5 mg) in 10 mL of water was stirred at room temperature for 12 h. The mixture was dialyzed against water (500 mL) using Spectrapor™ membrane tubing with molecular weight cut at 6,000 Dalton (6.4 mL/cm) for 14 h, then 5 h, and then 12 h. The presence of bipyridinium ligands on the magnetic Fe₂O₃ nanoparticles significantly improved the water solubility of the product Fe₂O₃ nanoparticles as up to about 300 mgs of the magnetic iron oxide nanoparticles could be dissolved in 1 mL of distilled water at 25° C. Transmission electron microscopy (TEM) analyses showed that these particles had a desired very narrow size distribution with an average core dimension of 13±1 nm in the buffer solutions of pH 3 (FIG. 5A), pH 7 (FIG. 5B), and 9 (FIG. 5C). In this Example biotin replaces the bromide salt with a mixture of biotin and bromide salt.

### E. Preparation of Water-Soluble Fe₂O₃ Nanoparticles Coated with N-methyl-N′-(6-carboxylhexyl)-4,4′-bipyridinium Iodide Bromide Salt (FIG. 3) by Oxidative Synthesis

N-Methyl-N′-(6-carboxylhexyl)-4,4′-bipyridinium iodide bromide salt (278.7 mg) was dissolved in 3 mL of N,N′-dimethylformamide and the resulting solution was heated to 100° C. under Ar protection. Then 0.05 mL of Fe(CO)₅ was added into the aforementioned solution. The mixture was heated to reflux and kept at this temperature for 1 h. The solution was then gradually cooled down to room temperature and trimethylamine-N-oxide (85 mg) was added. The mixture was then heated to 130° C. under Ar protection and maintained at this temperature for 2 h. The solution was then brought to reflux. After 1 h, the solution was slowly cooled down to room temperature and 100 mL of ethanol was added. The black residues were separated by centrifugation (15,000×G, 30 min). The obtained powders could be re-dissolved in methylene chloride solution, and further purified by adding polar solvents like ethanol and acetonitrile followed by centrifugation (15,000×G, 30 min). A typical yield of 40 mg can be achieved via this approach. This is a alternative process to prepare magnetic iron oxide nanoparticle crystals coated with bromide salt.

### Example 4

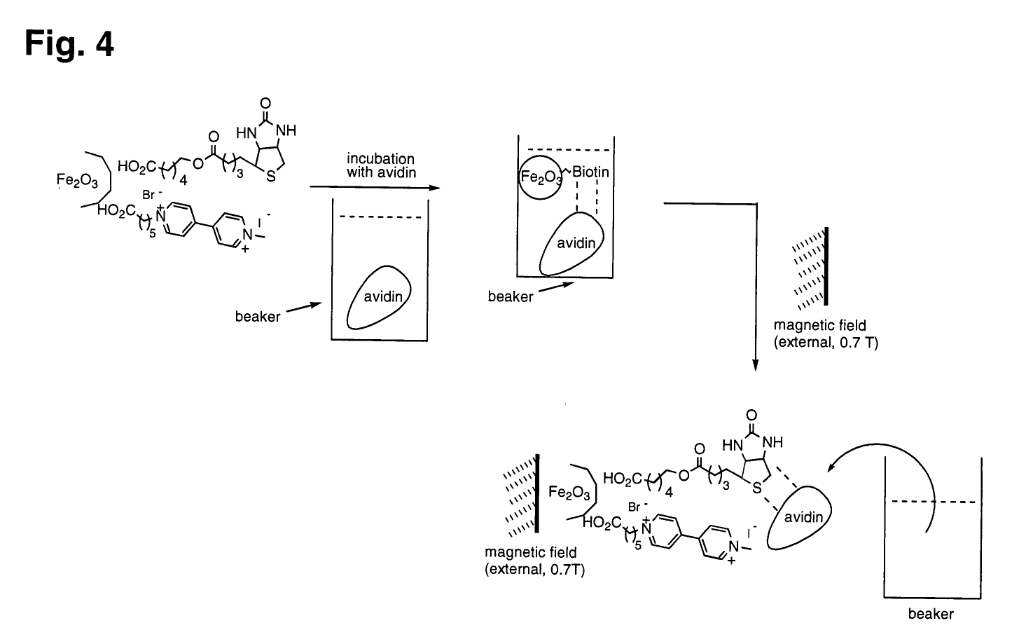

### Example 4 Shows Use of Water-Soluble Fe₂O₃ Nanoparticles Coated with d-(+)-Biotin and N-methyl-N′-(6-carboxylhexyl)-4,4′-bipyridinium Iodide Bromide Salt for the Affinity Isolation of the Protein Avidin (FIG. 4). In this Example, Biotin Replaces the Bromide Salt with a Mixture of Biotin and Bromide Salt

The assay was performed in 1 mL of phosphate-buffered saline (0.1 M, pH 7.4) solution comprising 12 mg of Fe₂O₃ coated with d-(+)-Biotin and N-methyl-N′-(6-carboxylhexyl)-4,4′-bipyridinium iodide bromide salt (prepared as described above) and avidin labeled with fluorescein isothiocyanate (avidin-FITC) (100 μU).

Native avidin is a tetrameric protein composed of four identical subunits. Each subunit is glycosylated at 17-Asparagine and has one binding site for d-biotin. One unit of avidin activity is defined as the amount of protein which will bind 1 mg of d-biotin or of HABA (4-hydroxyazobenzene-2′-carboxylic acid). See Biochem. J.; 89, 599 (1963). Avidin also includes deglycosylated which is obtained by the total removal of carbohydrate moieties of the native Avidin.

Biotin is the cofactor required of enzymes that are involved in carboxylation reactions, e.g. acetyl-CoA carboxylase and pyruvate carboxylase. Biotin is found in numerous foods and also is synthesized by intestinal bacteria.

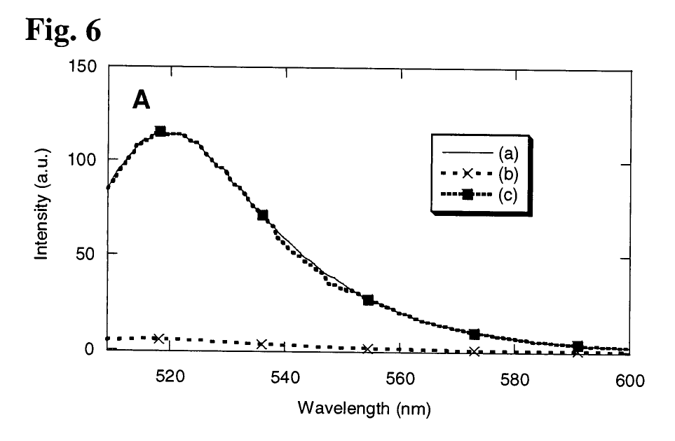

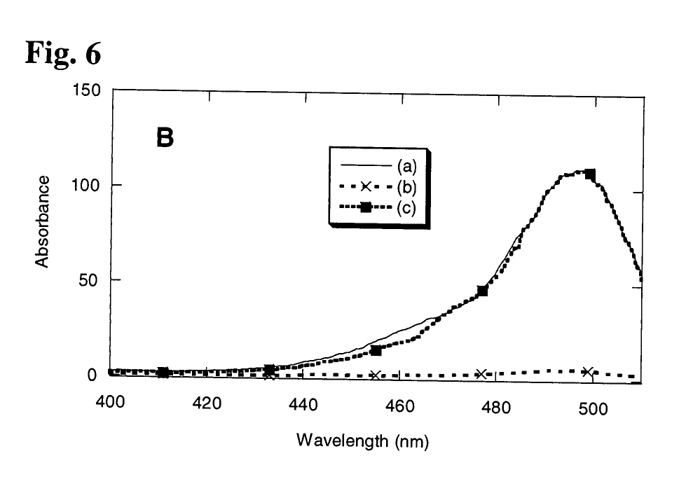

The resultant solution was incubated at 37° C. for 2 h, after which the magnetic nanoparticles were separated magnetically for 20 min using an external permanent magnet (0.7 Tesla). The separation was repeated three more times to ensure the complete removal of Fe₂O₃ nanoparticles. The fluorescence spectra of the avidin-FITC solution recorded before the addition of nanoparticles for incubation (line (a)) and after magnetic removal of the Fe₂O₃ nanoparticles coated with d-(+)-biotin (line (b)) are shown in FIG. 6A, indicating that 96% of avidin was removed from the buffer. This conclusion was also supported by examining the absorption spectra of avidin-FITC (FIG. 6B). The binding of the Fe₂O₃ nanoparticles coated with d-(+)-biotin and avidin-FITC appeared to be specific since similar studies using those biotin-free nanoparticles and avidin-FITC did not lead to the decay of florescence and absorption signals of avidin-FITC (FIGS. 6A and B).

### Example 5

### Example 5 Shows the Preparation of the Hydrophobic and Hydrophilic Core/Shell Fe₂O₃ Nanoparticles via the Surface-Initiated Polymerization

### A. Synthesis of 10-Carboxydecanyl 2—Bromo-2-methyl-thiopropanoate as an Initiator

Tiethylamine (15 mmol, 2.12 ml) and 2-bromoisobutyryl bromide (5 mmol, 0.63 ml) were mixed in a dry THF (tetrahydrofuran) solution (20 ml) at ambient temperature followed by the addition of 11-mercaptoundecanoic acid (5 mmol, 1.15 g) dropwise. The mixture was stirred at room temperature for 3 h. THF solvent was then removed in vacuo and 20 mL of diethyl ether was added. The organic layer was washed with 0.1 M HCl (20 ml) aqueous solutions three times and saturated brine solution (20 ml) sequentially. The organic phase was dried over anhydrous sodium sulfate and the solvent was removed in vacuo to give a residue that was purified by flash chromatography (hexane:ethyl acetate/30:1, 0.2% acetic acid) to give the desired product in 35% yield. ¹H NMR (300 MHz, CDCl₃) δ 2.9( m, 2H), 2.35 (m, 2H), 1.96 (s, 6H), 1.3-1.62( m, 16H). MS m/z 368 (57, [M+1]⁺).

Freshly prepared γ-Fe₂O₃ nanocrystals coated with oleate was prepared by dissolving oleate (278.7 mg) was in 3 mL of octyl ether and the resulting solution was heated to 100° C. under Ar protection. Then 0.05 mL of Fe(CO)₅ was added into the aforementioned solution. The mixture was heated to reflux and kept at this temperature for 1 h. The solution was then gradually cooled down to room temperature and trimethylamine-N-oxide (85 mg) was added. The mixture was then heated to 130° C. under Ar protection and maintained at this temperature for 2 h. The solution was then brought to reflux. After 1 h, the solution was slowly cooled down to room temperature and 100 mL of ethanol was added. The black residues were separated by centrifugation (15,000×G, 30 min). The obtained powders could be re-dissolved in methylene chloride solution, and further purified by adding polar solvents like ethanol and acetonitrile followed by centrifugation (15,000×G, 30 min). A typical yield of 140 mg can be achieved via this approach.

### B. Synthesis of the Hydrophobic Core/Shell Fe₂O₃/Polystyrene Nanoparticles (FIG. 7)

The mixture of initiator 10-carboxydecanyl 2-bromo-2-methyl-thiopropanoate (72 mg, 0.196 mmol) and freshly prepared γ-Fe₂O₃ nanocrystals coated with oleate (220 mg) (prepared as above) in 20 mL of CHCl₃ was stirred at ambient temperature for 24 h under Ar protection.

Resulting Fe₂O₃ nanoparticles were collected magnetically using an external permanent magnet (0.7 T) and repeatedly washed with acetonitrile (20 mL×3). Then, these nanoparticles were added into a 20 mL xylene solution of CuBr (43 mg, 0.3 mmol), 4,4′-dinoyl-2,2′-dipyridyl (DNDP) (450 mg, 1.1 mmol) and styrene (8 mL, 70 mmol). (CuBr=Copper (I)Bromide)

After 24 h at 135° C. under Ar, the solution was cooled down to room temperature and the particles were magnetically collected and repeatedly washed with toluene (20 mL×3). The infrared spectroscopy of the dried product indicates the presence of polystyrene on the surface of the nanoparticles. Characteristic peaks of polystyrene at 2800-3100 and 1200-1600 cm⁻¹ were observed, which were not present in the spectrum of Fe₂O₃ nanoparticles coated with oleic acid and the initiator. The formation of the polystyrene molecules was also supported by the ¹H NMR and gel permeation chromatography (GPC) analysis of the organic polymeric shell of the nanoparticles after HCl dissolution of the Fe₂O₃ cores. Transmission electron microscopy (TEM) studies confirmed that these nanoparticles have very narrow size distributions with an average core dimension of 13 nm.

### C. Synthesis of the Hydrophobic Core/Shell Fe₂O₃ Nanoparticles Protected with the Divinylbenzene-Crosslinked Polystyrene (FIG. 8)

The mixture of initiator 10-carboxydecanyl 2-bromo-2-methyl-thiopropanoate (72 mg, 0.196 mmol) (prepared as described above) and the freshly prepared γ-Fe₂O₃ nanocrystals coated with oleate (220 mg) (prepared as described above) in 20 mL of CHCl₃ was stirred at ambient temperature for 24 h under Ar protection.

The resulting oleated coated Fe₂O₃ nanoparticles were collected magnetically using an external permanent magnet (0.7 T) and repeatedly washed with acetonitrile (20 mL×3).

Then, these nanoparticles were added into a 20 mL xylene solution of CuBr (43 mg, 0.3 mmol), 4,4′-dinoyl-2,2′-dipyridyl (DNDP) (450 mg, 1.1 mmol), styrene (8 mL, 70 mmol) and divinylbenzene (DVB) (0.8 mL). After 24 h at 135° C. under Ar, the solution was cooled down to room temperature and the particles were magnetically collected and repeatedly washed with toluene.

Infrared spectroscopy of the dried product indicates the presence of polystyrene on the surface of the nanoparticles. Characteristic peaks of polystyrene at 2800-3100 and 1200-1600 cm⁻¹ were observed, which were not present in the spectrum of the precursor Fe₂O₃ nanoparticles coated with oleic acid and initiator.

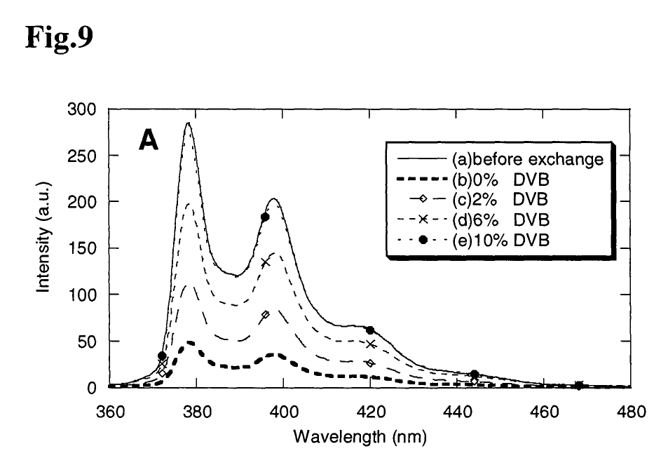

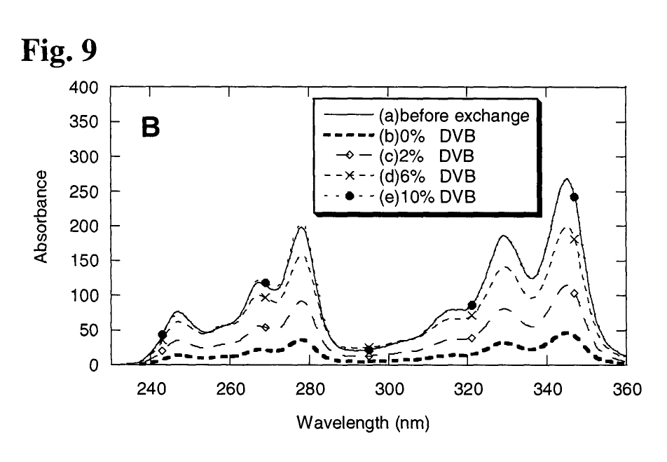

The formation of the desired product divinylbenzene-crosslinked polystyrene molecules was supported by the fluorescence measurements. To this end, we placed 2.5 mg of the core/shell Fe₂O₃ nanoparticles protected with a 10% divinylbenzene-crosslinked polystyrene shell into a CHCl₃ solution (10 mL) of 6-(1-pyrenyl)hexanoic acid (1 mg, 3.16 μmol). After stirred at ambient temperature for about 96 h, the nanoparticles were magnetically concentrated using a permanent magnet of 0.7 T. The solution was removed and the nanoparticles were washed three times with CHCl₃ (20 mL). The organic solutions were combined, dried over anhydrous sodium sulfate and concentrated to a final volume of 10 mL. The fluorescence spectrum (FIG. 9A) of the aforementioned solution after the site-exchange reaction (line e, diluted 2,500 folds) and the one of 6-(1-pyrenyl)hexanoic acid measured before the introduction of Fe₂O₃ nanoparticles (line a, diluted 2,500 folds) suggest that pyrene molecules were not adsorbed onto the surface of Fe₂O₃ particles protected with 10% DVB-crosslinked polystyrene during the site-exchange reaction. This conclusion was also supported by the absorption spectra in FIG. 9B (lines a and e). Presumably the 10% DVB-crosslinked polystyrene shell serves like a cage, preventing the competitive binding of 6-(1-pyrenyl)hexanoic acid onto the surface of Fe₂O₃ cores. However, lighter DVB-crosslinked polystyrene shells are less effective at shielding the adsorption of the pyrene probes onto the surface of the metal oxide cores. The calculations based on the fluorescent intensities at 378 nm in FIG. 9A suggested that about 83%, 61% and 31% of 6-(1-pyrenyl)hexanoic acid molecules were exchanged onto the surfaces of nanoparticles for the 0%, 2% and 6% DVB-crosslinked polystyrene shells, respectively. This was also supported by the similar calculations from the absorption spectra in FIG. 9B.

### D. Solvent-Free Synthesis of the Hydrophobic Core/Shell Fe₂O₃ Nanoparticles Protected with the Divinylbenzene-Crosslinked Polystyrene

The Fe₂O₃ nanoparticles protected with the initiator 10-carboxydecanyl 2-bromo-2-methyl-thiopropanoate (15 mg) (prepared as described in Example 5 Part A) were mixed with CuBr (8 mg), 4,4′-dinoyl-2,2′-dipyridyl (DNDP) (50 mg), styrene (2 mL) and divinylbenzene (DVB) (0.2 mL). After 24 h at 120° C. under Ar, the solution was cooled down to room temperature and the particles were magnetically collected and repeatedly washed with toluene. These particles were subjected to the similar tests mentioned above in Example 5 Part B.

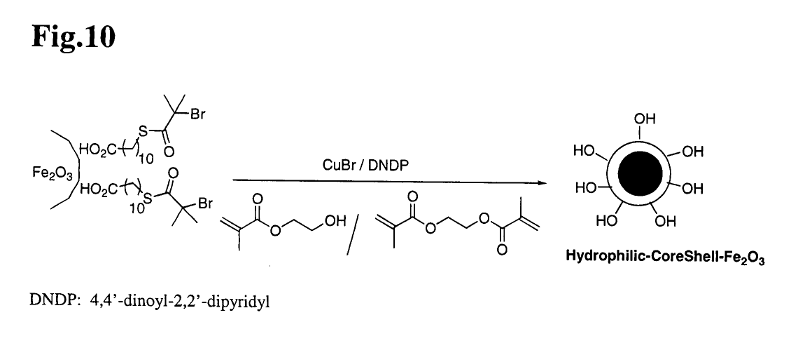

### E. Synthesis of the Hydrophilic Core/Shell Fe₂O₃ Nanoparticles Protected with the Ethylenedimethacrylate-Crosslinked Poly(2-Hydroxyethyl Methacrylate) (FIG. 10)

The Fe₂O₃ nanoparticles protected with the initiator 10-carboxydecanyl 2-bromo-2-methyl-thiopropanoate (130 mg) (prepared in Example 5 Part A) were mixed with CuBr (224 mg), 4,4′-dinoyl-2,2′-dipyridyl (DNDP) (0.55 mmol), 2-hydroxyethyl Methacrylate (4.2 mL) and ethylenedimethacrylate (0.3 mL). The reaction mixture was stirred at 90° C. for 24 hrs. After 24 h at 120° C. under Ar, the solution was cooled down to room temperature and the particles were magnetically collected and repeatedly washed with chloroform and acetonitirile to yield 200 mg of the core/shell nanoparticles.

### F. Synthesis of the Water-Soluble Core/Shell Fe₂O₃ Nanoparticles Linked with Ethylenediaminetetracetic Acid (FIG. 11)

The hydrophilic core/shell Fe₂O₃ nanoparticles protected with the 5% ethylenedimethacrylate-crosslinked poly(2-hydroxyethyl methacrylate) (36.7 mg) were dissolved in 15 ml of N,N′-dimethylformamide (DMF), and to it was added 8.5 mg of N,N′-dicyclohexylcarbodiimide (DCC) (0.041 mmol), and 12 mg of ethylenediaminetetracetic acid (0.041 mmol), and the reaction was setup for 14 hrs. The nanoparticles were then magnetically removed and washed with chloroform (20 mL×3) to remove any unreacted material. Then the nanoparticles were finally dispersed in chloroform. About 157 mg of nanoparticles were obtained. The IR analysis confirmed the presence of the carboxyl group at the wavenumber of 1714 cm⁻¹ and the presence of the hydroxyl group at 3300 cm⁻¹.

### G. Synthesis of the Hydrophobic Core/Shell Fe₂O₃ Nanoparticles Protected with the Divinylbenzene-Crosslinked Polystyrene from Fe₂O₃ Nanoparticles Coated with Oleate and 11-Mercaptoundecanoic Acid

The mixture of 11-mercaptoundecanoic acid (11 mg) and freshly prepared γ-Fe₂O₃ nanocrystals coated with oleate (220 mg) (as discussed above) in 20 mL of CHCl₃ was stirred at ambient temperature for 24 h under Ar protection. To this mixture, triethylamine (21 μL) and 2-bromoisobutyryl bromide (6 μL) were added at ambient temperature. The mixture was stirred at room temperature for 3 h.

Resulting Fe₂O₃ nanoparticles were collected magnetically using an external permanent magnet (0.7 T) and repeatedly washed with acetonitrile (20 mL×3). Then, these nanoparticles were added into a 20 mL xylene solution of CuBr (4.3 mg), 4,4′-dinoyl-2,2′-dipyridyl (DNDP) (45 mg) and styrene (8 mL, 70 mmol). (CuBr=Copper (I)Bromide). After 24 h at 135° C. under Ar, the solution was cooled down to room temperature and the particles were magnetically collected and repeatedly washed with toluene. The nanoparticles were subjected to the same testes discussed in Example 5B.

Example 6 shows the removal and concentration of Pb²⁺ from aqueous solutions.

To a 10 ml of lead nitrate aqueous solution (0.5 ppm), the core/shell Fe₂O₃ nanoparticles coated with ethylenediaminetetracetic acid (50 mg) (prepared in Example 5 Part A) was added. After 48 h at room temperature, the magnetic nanoparticles were magnetically concentrated using a 0.7 T permanent magnet. The aqueous solution was transferred out by a pipette, and the Pb²⁺ concentration was found to be 0.34 ppm. About 32% of Pb²⁺ was successfully removed by the Fe₂O₃ nanoparticles coated with ethylenediaminetetracetic acid.

Example 7. shows the replacement reaction on the surfaces of the Fe₂O₃ nanoparticles (FIG. 12).

The Fe₂O₃ nanoparticles (core size: 13 nm) protected with 10% divinylbenzene-crosslinked polystyrene (15 mg) in 5 mL of toluene solution (prepared in Example 5B) was treated with sodium hydride (1 mg, 4.18×10⁻² mmol) at room temperature. Then a mixture of 1-pyrenemethanol (9.7 mg, 4.18×10⁻² mmol) and tetrabutylammonium bromide (0.5 mg) in 2 mL of toluene was added. After 24 h at ambient temperature, the nanoparticles were magnetically removed by using a 0.7 T permanent magnet. The nanoparticles were washed six times with toluene (40 mL) to remove the contaminants and yield about 12 mg of the nanoparticles. To determine whether the pyrene molecules were attached to the surfaces of nanoparticles, the inventor treated the nanoparticles with concentrated HCl solution. After 2 h, the HCl solution was extracted with toluene (5 mL) five times. The combined organic layers were washed with saturated NaHCO₃ (15 mL), and dried over anhydrous Na₂SO₄. The Na₂SO₄ salt was removed by a simple filtration and the filtrate was further diluted 10³ folds with toluene. Fluorescence examinations of the diluted toluene solution at room temperature confirmed that the divinylbenzene-crosslinked polystyrene polymers have been labeled with the pyrene chromophores.

Example 8 depicts a simultaneous removal of nanoparticles from different wells on a plate using an overhead magnetic array with multiple magnetic pins (FIG. 13).

The test utilized a 6×4 multi-well plate that had a length of 12.4 cm and a width of 8 cm. Each well has a diameter of 1.6 cm and is 2 cm tall. To each well, the inventor added about 100 mg of γ-Fe₂O₃ nanocrystals coated with N-methyl-N′-(6-carboxylhexyl)-4,4′-bipyridinium iodide bromide salt (prepared following Example 3B) in 1 mL of distilled water. Three rectangular 0.05 T magnetic pins (0.5 cm×0.5 cm×2.5 cm) were fixed on a long beam using one of the 0.5 cm×0.5 cm square facet. Three rectangular 0.05 T pins are parallel and are 1.5 cm away to each other. Three pins were merged into three neighboring wells on the plate. After 10 min, the supporting beam was raised and the magnetic pins were removed out of the aqueous solutions. The surfaces of three magnetic pins that had contacts with the aqueous solutions were covered with reddish Fe₂O₃ nanoparticles. The particles were removed from the pins and air dried. About 85, 73 and 87 mgs of nanoparticles were successfully recovered from three pins, respectively.

Example 9 depicts a simultaneous removal of magnetic nanoparticles from different wells on a plate using underneath permanent magnets (FIG. 14).

This test utilized a 6×4 well plate having a length of 12.4 cm and a width of 8 cm. Each well has a diameter of 1.6 cm and is 2 cm tall. To each well, the inventor added about 100 mg of γ-Fe₂O₃ nanocrystals coated with N-methyl-N′-(6-carboxylhexyl)-4,4′-bipyridinium iodide bromide salt in 1 mL of distilled water. Two rectangular 0.05 T magnetic pins (0.5 cm×0.5 cm×2.5 cm) were placed under two wells using one of the 0.5 cm×0.5 cm square facet. After 10 min, the solutions in that two wells were removed by using a pipette while the magnetic pins were attached underneath. The bottoms of those three wells were covered with reddish Fe₂O₃ nanoparticles. After air drying, about 24 and 35 mgs of nanoparticles were recovered from two wells, respectively.

Example 10 shows the use of Fe₂O₃ nanoparticle-supported catalysts for promoting a Diels-Alder reaction.

### A. Synthesis of the Fe₂O₃ Nanoparticles Coated with MOM (methoxymethyl)-Protected (R)—Bi-2-naphthol

(R)—Bi-2-naphthol analogue, (R)-ethyl 4-(2,2′-dimethoxymethyl-1,1′-binaphth-6-yl)butanoate (20 mg, 4.48×10⁻² mmol) in 10 mL of dry toluene was treated with 2.4 mg of sodium hydride (0.1 mmol). After 1.5 h at ambient temperature, the Fe₂O₃ nanoparticles (core size: 13 nm) protected with 10% divinylbenzene-crosslinked polystyrene (104 mg) and 4.8 mg of tetrabutylammonium bromide in 5 mL of toluene was added. The mixture was then stirred at room temperature for 24 h. The nanoparticles were magnetically removed by using a 0.7 T permanent magnet and washed with toluene (15 mL) six times to remove any contaminants.

### B. Synthesis of the Fe₂O₃ Nanoparticles Coated with (R)—Bi-2-naphthol

The mixture of pyridinium p-toluenesulfonate (11.2 mg, 4.48×10⁻² mmol) and the Fe₂O₃ nanoparticles coated with MOM-protected (R)—Bi-2-naphthol (123 mg) in 20 mL of CHCl₃ was brought to reflux under Ar protection. After 24 h, the solution was cooled down to ambient temperature. The nanoparticles were magnetically collected and repeatedly washed with chloroform (30 mL, six times) to yield about 120 mg of the Fe₂O₃ nanoparticles coated with (R)—Bi-2-naphthol.

### C. The Diels-Alder Cycloaddition Catalyzed by the Fe₂O₃ Nanoparticles Coated with (R)—Bi-2-naphthol

A round-bottom flask was charged with powdered molecular sieves 4 Å (0.75 g), the Fe₂O₃ nanoparticles coated with (R)—Bi-2-naphthol (15 mg) in 10 mL of CH₂Cl₂. After the mixture was stirred at room temperature for 20 min, diisopropoxytitanium chloride (35 mg) was added into the resulting solution. After 1 h, the suspension was subjected to centrifugation (4000 rpm, 20 min). The resultant supernatant was transferred out into a round-bottom flask and the solvent was removed in vacuo. The resulting residue was re-dissolved in dry toluene (5 mL). A solution of the freshly distilled 1-acetoxy-1,3-butadiene (178 mg, E/Z=65:35 from Aldrich) and methacrolein (140 mg) in toluene (10 mL) was added. After 18 h at room temperature, the reaction was quenched with saturated NaHCO₃ solution (15 mL). Magnetic nanoparticles were removed magnetically using a 0.7 T permanent magnet. The organic layer was separated from the aqueous NaHCO₃ phase and dried over anhydrous Na₂SO₄. The CHCl₃ solvent was removed in vacuo to give the residues that were purified by the flash chromatography to yield about 210 mg of the Diels-Alder adduct: ¹H NMR (CDCl₃, 300 MHz): δ 1.08 (s, 3H), 1.66 (m, 1 H), 1.98 (m, 1 H), 2.05 (s, 3H), 2.05-2.28 (m, 2 H), 5.26-5.31 (m, 1 H), 5.78 (m, 1 H), 5.97 (m, 1 H), 9.69 (s, 1 H). MS m/z 183 [M+1]⁺.

While the invention has been described in terms of various specific embodiments, those skilled in the art will recognize that the invention can be practiced with modification within the spirit and scope of the claims.

What is claimed is:

1. A coated magnetic nanocrystal comprising magnetic oxide nanocrystals having a particle size in the range from about 0.1 nm to about 1000 nm.

2. A coated magnetic nanocrystal in accordance with claim 1 wherein the nanocrystal is a multi-component composition and has an outer coating composition comprising at least one of a surfactant and a ligand.

3. A coated magnetic nanocrystal in accordance with claim 2 having a core, said core having a narrow particle size distribution of as low as ±10%, and a coating wherein the coating comprises a ligand with at least one functional group.

4. A coated magnetic nanocrystal in accordance with claim 1 wherein the ligand comprises a place exchangeable ligand.

5. A process for preparing a multi-component coated magnetic nanocrystal with an inner composition comprising magnetic oxide nanocrystals having a narrow size distribution of as low as ±10% and an outer coating composition comprising at least one of a ligand and a surfactant which comprises oxiding a metal composition suitable for use as an inner composition with an oxidant in the presence of excess surfactant.

6. A magnetic nanocrystal composition in accordance with claim 5 wherein said composition comprises a magnetic iron oxide nanocrystal.

7. A process for preparing a multicomponent coated nanocrystal composition comprising an inner composition comprising magnetic oxide nanocrystals and an outer composition comprising a coating further comprising a place exchangeable ligand which comprises admixing a surfactant coated magnetic particle core with an aqueous composition comprising a water soluble ligand.

8. A process in accordance with claim 7 for preparing a ligand coated magnetic oxide nanoparticle core which further comprises admixing a surfactant coated magnetic particle core with a water solubilizing coating composition comprising a water soluble ligand.

9. A process in accordance with claim 8 for preparing a replacement coated magnetic nanoparticle core which comprises place exchanging said ligand of the coating composition with a replacement coating.

10. A process for preparing magnetic nanoparticles having inorganic magnetic nanoparticle core protected with a layer(s) of organic polymeric coatings, which comprises admixing a polymerizable monomer with a composition containing a magnetic particle optionally in the presence of an initiator, and polymerizing the monomer over a magnetic nanoparticle core.

11. A process in accordance with claim 10 wherein the polymerization is carried out to a degree which provides a desired molecular weight and molecular weight distribution.

12. A process in accordance with claim 11 wherein the coating on the coated magnetic particle possesses a functionality that links polymerizable monomers attached and/or not attached to the surface of inorganic magnetic nanoparticles.

13. A process for using magnetic nanoparticles as a host for hosting a moiety selected from the group consisting of reagent, catalyst, scavenger, reaction byproduct, product and intermediate which comprise utilizing as a coating on the coated magnetic nanoparticle a coating comprising at least one of an organic molecule, polymer including crosslinked polymer, biological polymers, silica having a functional affinity for a reagent, catalyst, scavenger, reaction byproduct and product.

14. A process in accordance with claim 13 wherein the hosting is carried out by effectively contacting a composition containing at least one of a reagent, catalyst, scavenger, reaction byproduct, product and any intermediate with a coated magnetic nanoparticle having a coating having an affinity for a reagent, catalyst, scavenger, reaction byproduct, product and any intermediate.

15. A process is provided for using magnetic nanoparticles for supporting organic and biological transformations, which comprises utilizing as a coating on coated magnetic nanoparticle a ligand coating comprising at least one of organic molecule, polymer including a crosslinked polymer, a biological polymer and silica which effectively exhibits a functional effective affinity for organic and biological transformations.

16. A process for preparing magnetic iron oxide nanocrystals having a narrow size distribution, said process comprising oxidizing a metal composition suitable as a magnetic nanocrystal, with a mild oxidant in the presence of excess organic surfactant.

17. A process in accordance with claim 16 wherein said metal composition is selected from at least one of iron alloy, iron oxide, rare earth metal, actinide, rare earth garnet, ortho ferrite, ilmenite and spinal ferrite.

18. A process in accordance with claim 17 wherein said magnetic composition is iron oxide.

19. A process in accordance with claim 18 wherein said organic surfactant comprises pentadecanoic acid.

20. A process for coating a magnetic particle core, said process comprising admixing a water solubilizing coating composition comprising a water soluble ligand onto the surface of said magnetic particle core and place exchanging said ligand with a replacement coating.

21. A process in accordance with claim 20 wherein said ligand comprises at least one of a synthesized organic compound or native compound.

22. A process in accordance with claim 21 wherein said biological molecule include proteins, nucleic acids, carbohydrates, lipids, antibodies/antigens, cells, subcellular organelles, biological molecules, and derivatives and combinations thereof.

23. A process in accordance with claim 20 wherein said water soluble ligand comprises pentadecanoic acid and said replacement coating comprises a thiol.

24. A process in accordance with claim 23 wherein said thiol comprises undecanethiol.

25. A process in accordance with claim 20 wherein said replacement coating comprises an alcohol.

26. A process in accordance with claim 25 wherein said alcohol comprises octanol.

27. A process in accordance with claim 20 wherein said replacement coating comprises a sulfonate.

28. A process in accordance with claim 27 wherein said sulfonate comprises decanesulfonic acid.

29. A process for preparing a water soluble magnetic composition having at least one an attached water solvable molecule or ligand attached thereon, said process comprising forming a magnetic particle composition having a first functional group attached to the surface thereof and coupling a ligand to said first functional group.

30. A process in accordance with claim 29 wherein said first functional group is selected from the group consisting of alcohol, amine, alkene, alkyne, aldehye, ketone, ether, phenol, aromatic molecule, alkyl halide, acid, acid halide, mercapto group, ester, thioester, acid anhydride, disulfide, phosphonate, sulfonate, nitro, cyano, phosphoric acid, phosphorous acid, phosphorus, phosphine oxide, ether, thioether, metal completes, metal organic groups, and derivates and any combinations hereof.

31. A process in accordance with claim 30 wherein said functional group is selected from an alcohol, sulfate and a phosphonate.

32. A water soluble magnetic composition having a core having a particle size distribution of ±10% and having a surface coating thereon said surface coating comprising a ligand attached to a functional group.

33. A composition in accordance with claim 32 wherein said functional group comprises a biological molecule.

34. A composition in accordance with claim 32 wherein said ligand is selected from the group that consists of a protein, nucleric acid, carbohydrate, lipid, antibody, antigen, cell and subcellular organelle.

35. A composition in accordance with claim 33 wherein said biological group is selected from at least one of a small molecule that binds to a minor groove of DNA, a molecule that forms an adduct with DNA and RNA, a molecule that intercalate between base pairs of DNA, radiomimetic DNA damaging agents (bleomycin, neocarzinostatin and other enediynes) and metal complexes that bind and/or damage nucleic acids through oxidation and chemical and photochemical probes of DNA.

36. A composition in accordance with claim 35 wherein said small compound has an affinity for a biological target.

37. A composition in accordance with claim 36 wherein the affinity is selected from the group consisting of van der Waals attraction, hydrophilic attractions, ionic, covalent and electrostatic or magnetic attraction of the compound to a biological target.

38. A composition in accordance with claim 35 wherein said compound is selected from at least one of small molecules, peptides, proteins, nucleic acids, antibodies, antigens, carbohydrates, lipids, cells, subcellular organelles and biological molecules.

39. A composition in accordance with claim 37 said compound includes at least one moiety selected from the group consisting of small molecule synthesis, peptide and nucleotide synthesis, carbohydrate synthesis and inorganic materials reactions.

40. A composition in accordance with claim 37 wherein said biological molecule can carry out a biological transformation including transformations converting substrates into products by enzymes or inhibiting enzymes with inhibitors.

41. A composition in accordance with claim 37 wherein said associated compound is a protein.

42. A composition in accordance with claim 40 wherein said protein compress a water soluble protein.

43. A composition in accordance with claim 37 wherein said transformation comprises using an enzyme.
